(19) United States
(12) Patent Application Publication
(10) Pub. No.: US 2026/0035205 A1
(43) Pub. Date: Feb. 5, 2026

(54) Collapsible Core System and Method

(71) Applicant: Brady Worldwide, Inc., Milwaukee, WI (US)

(72) Inventors: Krishnan Anish, Singapore (SG); Don Rodriguez David, Singapore (SG); Mui Heng Too, Singapore (SG); Ee Sin Yap, Singapore (SG); Matthew Luger, Wauwatosa, WI (US); Rebecca Vanselow, Brookfield, WI (US)

(21) Appl. No.: 18/790,100

(22) Filed: Jul. 31, 2024

(51) Int. Cl. B65H 75/22; B41J 33/00; B41J 35/28

(52) U.S. Cl. CPC B65H 75/2209; B41J 33/003; B41J 35/28

(57) ABSTRACT

A spindle for facilitating removal of used ribbon material in a printer is disclosed. The spindle includes a shaft movably attached to the printer and a spindle arm positioned on the shaft for collecting the used ribbon material. The spindle arm has a first side and a second side opposite the first side. The spindle includes a slider disposed between the shaft and the spindle arm and configured for bidirectional movement along the shaft between a first position and a second position. The spindle also includes a first wiper connected to the slider. A button is connected to the slider and operably engaging the shaft. Engaging the button permits movement of the slider along the shaft from the first position to the second position thereby causing the first wiper to move the used ribbon material toward an end of the spindle arm.

### CROSS-REFERENCE TO RELATED APPLICATIONS

None.

### BACKGROUND

Thermal transfer printers employ a digital printing method that uses a ribbon and a printhead to selectively transfer ink onto a substrate (e.g., paper or another form of printable media). This method is known in the art to produce high-quality, high-resolution, durable prints. For example, thermal transfer printers are commonly used to print labels (e.g., barcodes) that will be used for long-term applications or that will be exposed to harsh conditions such as heat, ultraviolet light, moisture, and chemicals. Thermal transfer printers are also capable of handling high-volume print jobs in an efficient and cost-effective manner. For these and other reasons, thermal transfer printers are commonplace in a variety of industries including retail, healthcare, manufacturing, and others.

However, thermal transfer printers present certain challenges, particularly with respect to installation and removal of the ribbon material that provides the ink used during printing operations. The ribbon material is generally provided in the form of a thin film coated on one side with ink (e.g., wax, resin, or a wax-resin compound) that is melted via the application of heat from a printhead and transferred onto a printable media to produce the desired print. A roll of unused ribbon material is installed on a supply spindle, and the ribbon material is guided along a desired ribbon path from the supply spindle to a take-up or waste ribbon spindle after being heated by the printhead. A spool of used ribbon material may accumulate on the take-up spindle while printing operations are performed.

When the printer has consumed all or part of the unused ribbon material from the supply spindle, the spool of used ribbon material can be removed from the take-up spindle to change the type of ribbon material being used, to install a fresh supply of ribbon material when the take-up spindle is full, or for other reasons. One of the challenges presented by thermal transfer printers is handling the rolls of ribbon material, particularly when removing the spool of used ribbon material from the take-up spindle. For example, the spool of used ribbon material, particularly the tightly wound inner layers of ribbon material adjacent to the take-up spindle, often resists easy removal. Incomplete removal of the spool requires users to expend additional time and energy in order to remove the used ribbon material, leading to inconvenience, wasted time, and customer dissatisfaction.

In some cases, a user must slice the layers of used ribbon material using, for example, a razor blade before the ribbon material can be manually removed from the take-up spindle. However, this process often requires the user to make several passes with the razor blade, which can be time-consuming and potentially dangerous in the event of a mistake or mishandling of the blade. Oftentimes, the entire spool of used ribbon material is manually removed in this way, which can require dozens of passes with the blade. Slicing the used ribbon material may cause pieces of the ribbon material to be scattered around a workspace surrounding the printer (requiring additional time and energy for cleanup) or to end up in undesirable locations within the printer, potentially causing damage thereto. Additionally, extensive handling of the used ribbon material can cause ink to stain the clothing and/or skin of a user.

Some devices have utilized a take-up spindle with a portion that is retractable to aid in removing used ribbon material. However, these devices typically require users to operate the second spindle using both hands. For example, one hand may need to stabilize a first portion of the take-up spindle while the other hand operates (e.g., retracts) a second portion. Additionally, this retraction is achieved using rotating or threaded components in some devices, which may increase complexity (e.g., by requiring rotation in a particular direction) or lead to wear and potential mechanical failure in some cases. As a result of at least the above problems, there exists a need for a mechanism that aids a user in conveniently and efficiently removing a spool of used ribbon material from a thermal printer.

### SUMMARY

The present systems and methods disclosed herein overcome many of the shortcomings and limitations of the prior art devices discussed above.

In one aspect, a spindle for facilitating removal of used ribbon material in a printer is disclosed. The spindle includes a shaft movably attached to the printer and a spindle arm positioned on the shaft for collecting the used ribbon material. The spindle arm has a first side and a second side opposite the first side. The spindle also includes a slider disposed between the shaft and the spindle arm. The slider is configured for bidirectional movement along the shaft between a first position and a second position. The spindle includes a first wiper connected to the slider and a button connected to the slider and operably engaging the shaft. Engaging the button permits movement of the slider along the shaft from the first position to the second position thereby causing the first wiper to move the used ribbon material toward an end of the spindle arm.

In another aspect, a collapsible core assembly for collecting used ribbon material in a printer is disclosed. The collapsible core assembly includes a shaft, a slider at least partially surrounding the shaft and configured to move therealong, a wiper connected to the slider, and an outer core at least partially surrounding the slider. The outer core forms a spindle arm configured to collect the used ribbon material. The outer core is in an expanded state during operation of the printer and in a collapsed state during removal of the used ribbon material from the spindle arm.

In a further aspect, a method of removing used ribbon material from a printer is disclosed. The method includes the step of providing a collapsible core assembly in an expanded state. The collapsible core assembly includes a slider disposed on a shaft movably connected to the printer, the slider disposed in a first position along the shaft, and a wiper connected to the slider. The collapsible core also includes a spindle arm partially surrounding the slider for collecting the used ribbon material, a locking mechanism operably engaging the slider, and a button operably connected to the locking mechanism. The method also includes the steps of receiving the used ribbon material on the spindle arm and disengaging the locking mechanism by depressing the button to release the slider from the first position. The method further includes the step of moving the slider along the shaft to a second position. Movement of the slider from the first position to the second position causes the collapsible core assembly to transition to a collapsed state and causes the wiper to push the used ribbon material along a portion of the spindle arm, thereby partially removing the used ribbon material from the spindle arm. The method also includes the steps of pushing the used ribbon material along the remainder of the spindle arm until the used ribbon material is removed from the collapsible core assembly and returning the slider to the first position such that the collapsible core assembly returns to the expanded state.

### BRIEF DESCRIPTION OF THE DRAWINGS

FIG. 1 illustrates a front, top, and left side isometric view of an exemplary printer in a closed configuration;

FIG. 2 illustrates a front, top, and right side isometric view of the printer of FIG. 1 in an open configuration;

FIG. 3 illustrates a front, top, and left side isometric view of several components of the printer of FIGS. 1 and 2 including an exemplary collapsible core assembly for use with the printer of FIGS. 1 and 2 constructed according to the teachings of the present invention;

FIG. 4 illustrates a front, top, and left side isometric view of the collapsible core assembly of FIG. 3;

FIG. 5 illustrates a left side elevational, cross-sectional view of the collapsible core assembly of FIG. 3 taken along the line 5-5 of FIG. 4;

FIG. 6 illustrates a left side elevational view of a shaft of the collapsible core assembly of FIG. 3;

FIG. 7 illustrates an enlarged view of a portion of the shaft of FIG. 6 with a first pin member connected to an end portion thereof;

FIG. 8 illustrates a top and left side isometric view of a slider of the collapsible core assembly of FIG. 3;

FIG. 9 illustrates a bottom plan view of the slider of FIG. 8;

FIG. 10 illustrates a front elevational view of the slider of FIG. 8;

FIG. 11 illustrates a top, front, and right side isometric view of a wiper of the collapsible core assembly of FIG. 3;

FIG. 12 illustrates a top, front, and left side isometric view of the shaft of FIG. 6, the slider of FIG. 8, and the wiper of FIG. 11, along with other components representing a portion of the collapsible core assembly of FIG. 3;

FIG. 13 illustrates a top, front, and left side isometric view of an inner core of the collapsible core assembly of FIG. 3;

FIG. 14 illustrates a left side elevational view of a sidewall portion of the inner core of FIG. 13;

FIG. 15 illustrates a top, rear, and left side isometric view of the inner core of FIG. 13;

FIG. 16 illustrates a top, front, and left side isometric view of the portion of the collapsible core assembly of FIG. 12 with the inner core of FIG. 13 installed thereon;

FIG. 17 illustrates a top, front, and left side isometric view of an outer core of the collapsible core assembly of FIG. 3;

FIG. 18 illustrates a rear elevational view of the outer core of FIG. 17;

FIG. 19 illustrates a bottom and left side isometric view of a first portion of the outer core of FIG. 17;

FIG. 20 illustrates a top and front isometric view of a second portion of the outer core of FIG. 17;

FIG. 21 illustrates a front elevational view of the outer core of FIG. 17;

FIG. 22 illustrates a top and front isometric view of the collapsible core assembly of FIG. 3;

FIG. 23 illustrates a left side elevational view of a cap of the collapsible core assembly of FIG. 3;

FIG. 24 illustrates a rear elevational view of the cap of FIG. 23;

FIG. 25 illustrates a top and front isometric view of the cap of FIG. 23;

FIG. 26 illustrates a top, rear, and left side isometric view of a button of the collapsible core assembly of FIG. 3;

FIG. 27 illustrates a left side elevational, cross-sectional view of the button of FIG. 26 taken along the line 27-27 of FIG. 26;

FIG. 28 illustrates a top, rear, and left side isometric view of a locking plate of the collapsible core assembly of FIG. 3;

FIG. 29 illustrates a top, front, and left side isometric view of a locking mechanism of the collapsible core assembly of FIG. 3 including the locking plate of FIG. 28;

FIG. 30 illustrates a top and left side isometric view of the cap of FIG. 23 connected to the slider of FIG. 8 with the locking mechanism of FIG. 29 disposed within the cap;

FIG. 31 illustrates a top plan view of the collapsible core assembly of FIG. 3 with the outer core of FIG. 17 removed;

FIG. 32 illustrates a front and left side isometric, cross-sectional view of the locking mechanism of FIG. 29 disposed within the cap of FIG. 23 and covered by the button of FIG. 26 taken along the line 32-32 of FIG. 31;

FIG. 33A depicts a first orientation in an unlocking action of the locking mechanism of FIG. 29 positioned between the cap of FIG. 23 and the button of FIG. 26;

FIG. 33B depicts a second orientation in an unlocking action of the locking mechanism of FIG. 29 positioned between the cap of FIG. 23 and the button of FIG. 26;

FIG. 33C depicts a third orientation in an unlocking action of the locking mechanism of FIG. 29 positioned between the cap of FIG. 23 and the button of FIG. 26;

FIG. 34A depicts a first orientation in a locking action of the locking mechanism of FIG. 29 positioned between the cap of FIG. 23 and the button of FIG. 26;

FIG. 34B depicts a second orientation in a locking action of the locking mechanism of FIG. 29 positioned between the cap of FIG. 23 and the button of FIG. 26;

FIG. 34C depicts a third orientation in a locking action of the locking mechanism of FIG. 29 positioned between the cap of FIG. 23 and the button of FIG. 26;

FIG. 34D depicts a fourth orientation in a locking action of the locking mechanism of FIG. 29 positioned between the cap of FIG. 23 and the button of FIG. 26;

FIG. 35 illustrates a front and left side isometric view of the collapsible core assembly of FIG. 3 in a first configuration with a spool of used ribbon material disposed thereon;

FIG. 36 illustrates a left side elevational, cross-sectional view of the collapsible core assembly of FIG. 3 in the first configuration with the spool of FIG. 35 disposed thereon taken along the line 36-36 of FIG. 35;

FIG. 37 illustrates a left side elevational, cross-sectional view of the collapsible core assembly of FIG. 3 in a second configuration with the spool of FIG. 35 partially removed therefrom taken along the line 37-37 of FIG. 38;

FIG. 38 illustrates a top, front, and left side isometric view of the collapsible core assembly of FIG. 3 in the second configuration with the spool of FIG. 35 partially removed therefrom; and

FIG. 39 is a flow chart illustrating a method of removing a spool of used ribbon material from a printer.

### DETAILED DESCRIPTION

Before any embodiments are described in detail, it is to be understood that the disclosure is not limited in its application to the details of construction and the arrangement of components set forth in the following description or illustrated in the following drawings, which is limited only by the claims that follow the present disclosure. The disclosure is capable of other embodiments, and of being practiced, or of being carried out, in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the disclosure.

Additionally, while the following discussion may describe features associated with specific devices or embodiments, it is understood that additional devices and/or features can be used with the described systems and methods, and that the discussed devices and features are used to provide examples of possible embodiments, without being limited.

The present disclosure is directed to a system designed to aid a user in removing a spool or roll of used ribbon material from a printer. The used ribbon material may be collected in a roll wound about a spindle arm. In some instances, an outer core of the spindle arm may transition from an expanded state to a collapsed state when the roll of ribbon material is removed, thereby reducing a tension on the tightly wound inner layers. Additionally, in some instances, the system may include a slider designed to move wipers across at least a portion of the length of the spindle arm. The wipers may at least partially remove a spool or roll of used ribbon material from the spindle arm such that a user can easily complete removal. In some instances, the system may incorporate a locking mechanism with a button that a user can operate with a single hand to initiate removal of the used ribbon material.

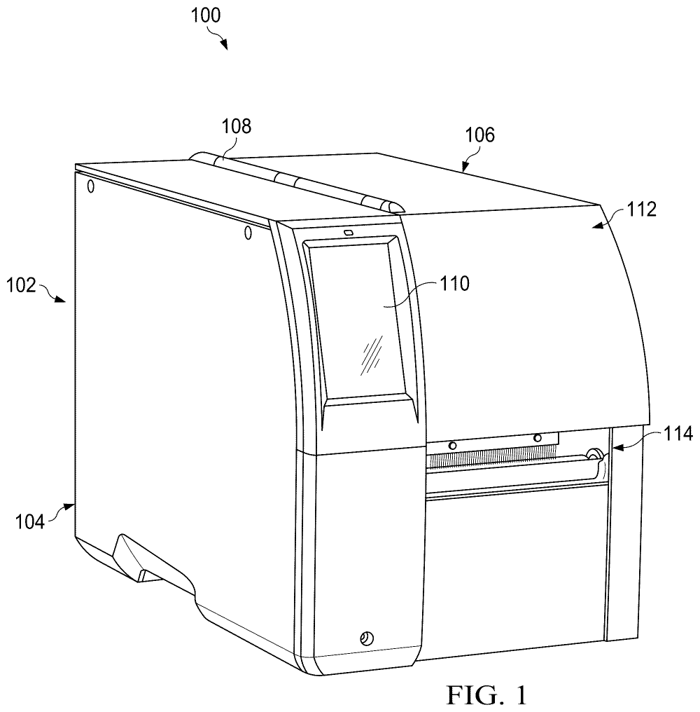

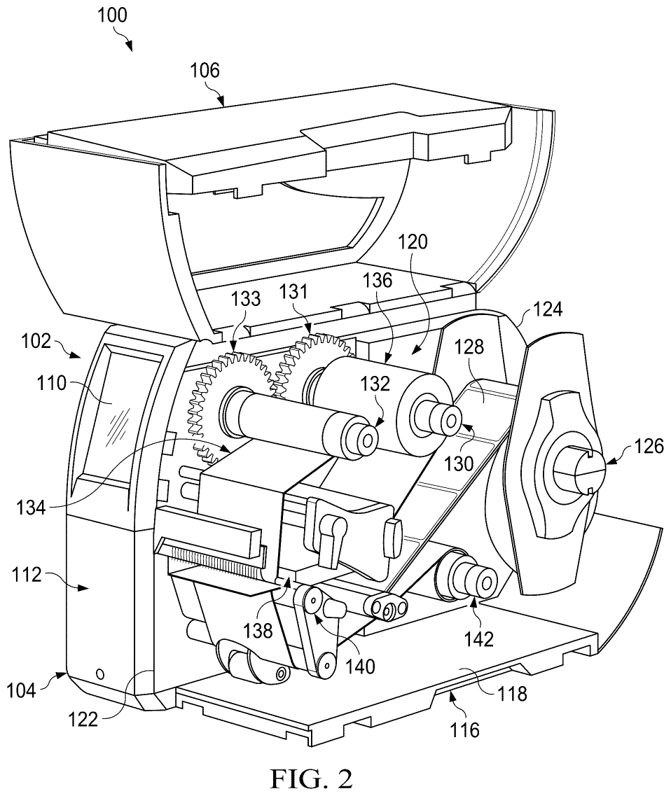

Referring first to FIGS. 1 and 2, an exemplary thermal transfer printer 100 is provided in the form of a housing 102 defining a base portion 104 and an enclosure cover 106. The base portion 104 and the enclosure cover 106 may be hingedly attached or otherwise coupled to one another such that the enclosure cover 106 may be removably opened and/or attached to allow access to the internal components of the printer 100 and to allow for installation or maintenance of the internal parts. For example, the enclosure cover 106 may be coupled to the base portion 104 via a hinge 108.

A user interface 110 may be located on a front face 112 of the printer 100. The user interface 110 may allow users to operate, service, or otherwise interface with the printer 100. For example, the user interface 110 may enable users to alter certain settings or preferences with respect to one or more print jobs. Additionally, the printer 100 may include an exit slot 114 provided in the form of a rectilinear opening between the base portion 104 and the enclosure cover 106 disposed on the front face 112. The exit slot 114 may provide an aperture through which printed media produced by the printer 100 may exit the printer 100, e.g., to be retrieved by a user.

As shown in FIG. 2, the enclosure cover 106 of the printer 100 is designed to move into an open configuration. In some instances, the enclosure cover 106 may be rotatable about an axis of connection with the base portion 104 formed by the hinge 108. Thus, a user may place the printer 100 in the open configuration by lifting the enclosure cover 106 away from the base portion 104 and causing the enclosure cover 106 to rotate about the hinge, thereby exposing one or more internal components of the printer 100.

The base portion 104 may include a chassis 116 configured to support one or more internal components of the printer 100. The chassis 116 may be provided in the form of a floor 118 and a mounting wall 120 oriented in a plane that is substantially perpendicular to the floor 118. The mounting wall 120 may be formed integrally with or coupled to the floor 118 and extend upwardly therefrom. The mounting wall 120 may be defined by a front end 122 (the front end 122 corresponding to the front face 112 of the printer 100) and a rear end 124 opposing the front end 122. In some instances, the chassis 116 may be formed from cast aluminum. In other instances, the chassis 116 may be formed from any other suitable material.

Internal components of the printer 100 may be connected directly to the mounting wall 120 of the chassis 116. For example, a media holder 126 may be connected to the mounting wall 120 and may be positioned adjacent to the rear end 124 of the chassis 116. The media holder 126 is designed to retain and dispense a printable media 128 (e.g., adhesive labels or any other suitable media) from a roll as the printer 100 operates. The media holder 126 may be configured to support printable media 128 of different sizes (e.g., labels having different widths).

The chassis 116 may also support a ribbon supply spindle 130 and a waste ribbon spindle 132 connected to the mounting wall 120. The ribbon supply spindle 130 may be positioned on the mounting wall 120 proximate to the media holder 126, and the waste ribbon spindle 132 may be positioned between the ribbon supply spindle 130 and the front end 122 of the mounting wall 120. The ribbon supply spindle 130 may include a gear member 131 and the waste ribbon spindle 132 may include a gear member 133. The gear member 131 and the gear member 133 may be configured to be engaged by a driven component (not shown) of the printer 100 such that the driven component may generate rotation of the ribbon supply spindle 130 and the waste ribbon spindle 132, respectively.

The ribbon supply spindle 130 is designed to retain and dispense a supply of ribbon material 134 from a ribbon roll 136 (e.g., in a manner similar to the media holder 126) as the printer 100 operates. During the printing process, printable media 128 from the media holder 126 and ribbon material 134 from the ribbon supply spindle 130 may each be directed toward the front end 122 of the mounting wall 120. The printable media 128 and the ribbon material 134 may converge proximate to a printhead 138 and a platen roller 140. The printhead 138 and platen roller 140 may each be connected to the chassis 116 and positioned proximate to the front end 122 of the mounting wall 120. For example, the printhead 138 and platen roller 140 may be positioned on the mounting wall 120 so that the printhead 138 and platen roller 140 are positioned adjacent to the exit slot 114 when the enclosure cover 106 is placed in a closed configuration.

During printing, the printable media 128 and ribbon material 134 may pass between the printhead 138 and the platen roller 140. The printhead 138 may be configured to apply heat to the ribbon material 134 passing beneath the printhead 138, thereby causing ink from the ribbon material 134 to melt and adhere to an adjacent portion of the printable media 128. At the same time, the platen roller 140 may be arranged to provide a smooth support surface to the printable media 128 and ribbon material 134 as they pass beneath the printhead 138 and come into contact with one another. For example, the platen roller 140 may apply a pressure against the printable media 128 and the ribbon material 134, thereby ensuring that each engages firmly with the printhead 138 and that ink from the ribbon material 134 is effectively transferred to the printable media 128.

Once the ink from the ribbon material 134 has been applied to the printable media 128 by the printhead 138, the printable media 128 may exit the printer 100 via the exit slot 114 and the used ribbon material 134 may be directed to and collected on the waste ribbon spindle 132. In some instances, rather than exiting the printer 100 via the exit slot 114, the printable media 128 may be directed back toward the rear end 124 of the mounting wall 120 where the printable media 128 may be collected by a rewinder 142. In this way, the printer 100 may generate as an end product a roll of printed media (e.g., a roll of printed labels) to be later retrieved by a user, rather than supplying the finished product directly to a user via the exit slot 114.

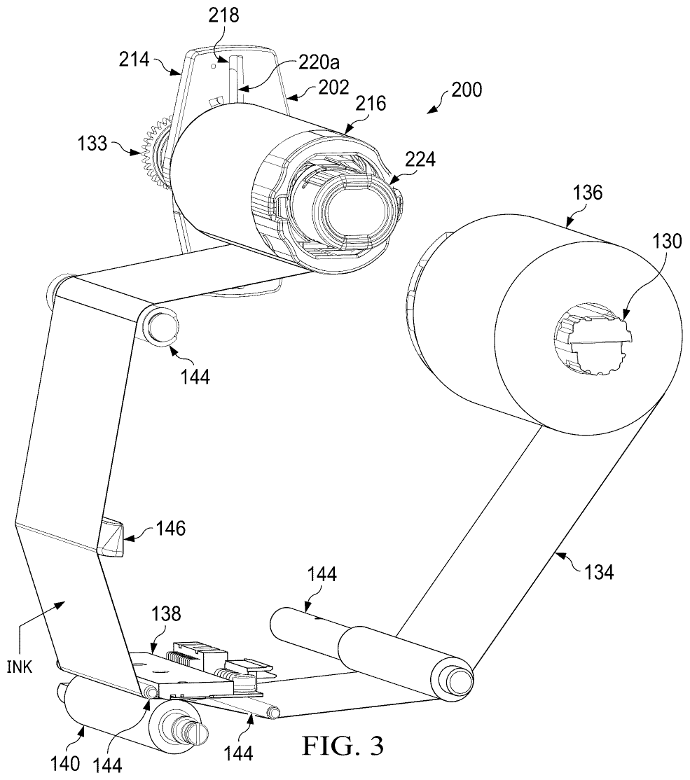

Turning to FIG. 3, in some instances, the waste ribbon spindle 132 may be provided in the form of a collapsible core assembly 200 designed to aid a user in removing used ribbon material 134 therefrom (e.g., to install a new ribbon roll 136 when the ribbon roll 136 is depleted). The printer 100 may include one or more rollers 144 and/or one or more diverters 146 arranged to deflect or guide the ribbon material 134 along a desired ribbon path. In some instances, the printer 100 may include four rollers 144 and one diverter 146 as shown in FIG. 3. In other instances, the printer 100 may include any number of rollers 144 and/or diverters 146, and the rollers 144 and diverters 146 may be arranged to guide the ribbon material 134 along any suitable path. During operation (e.g., of the printer 100), unused ribbon material 134 may be unwound from the ribbon roll 136 installed on the ribbon supply spindle 130, the ribbon material 134 may be guided along a desired ribbon path that passes between the printhead 138 and the platen roller 140 such that the ribbon material 134 can be acted on by the printhead 138, and used ribbon material 134 may be collected on the collapsible core assembly 200.

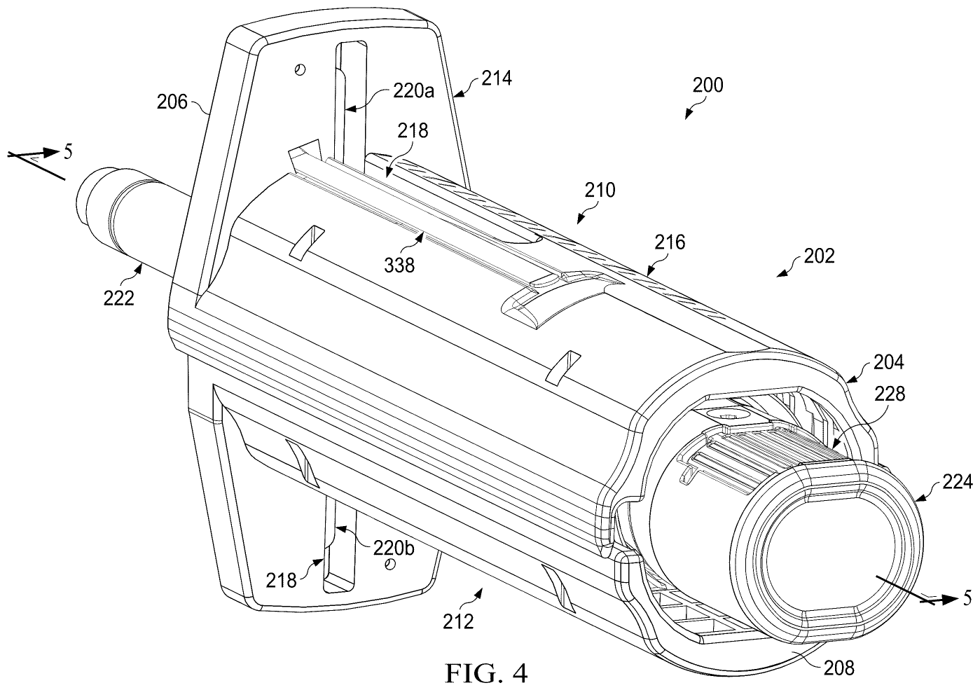

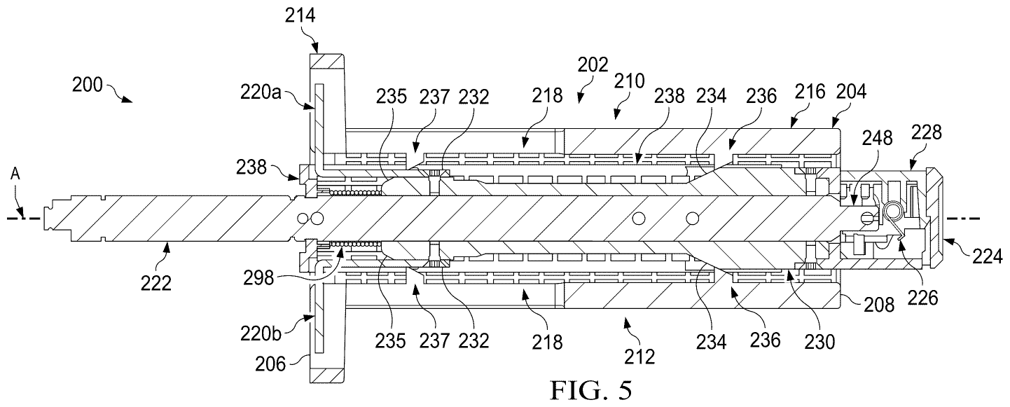

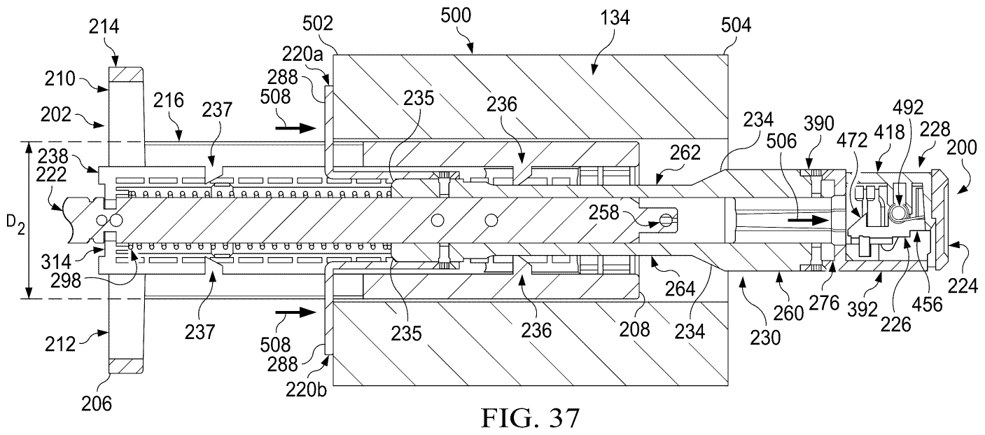

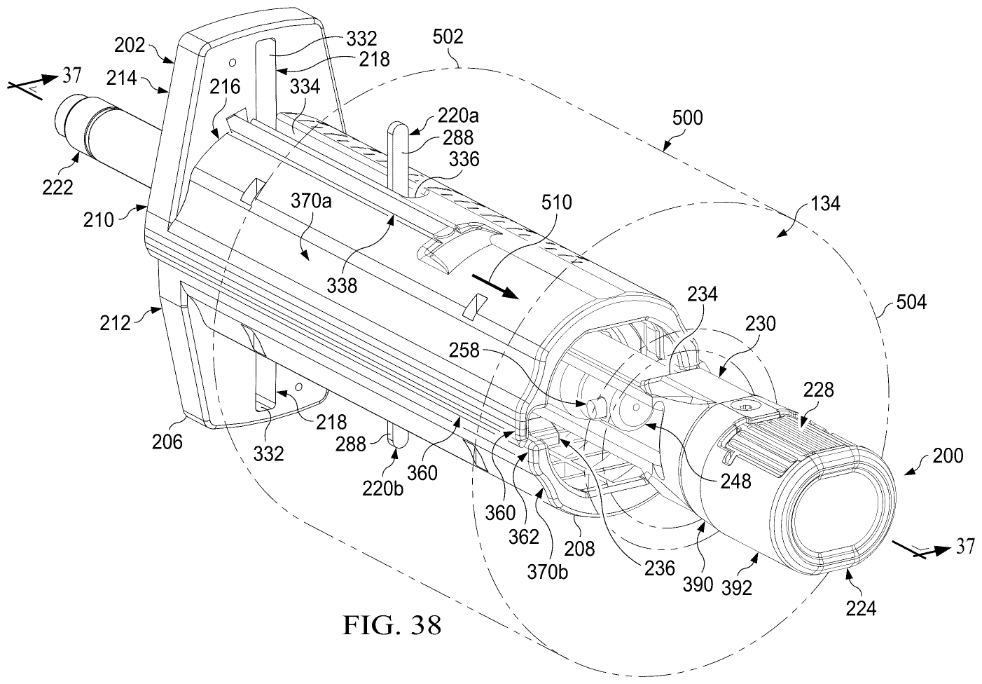

Turning to FIG. 4, the collapsible core assembly 200 may include a collapsible outer core 202 provided in the form of a substantially tubular outer core body 204 defined by an outer core first end 206 and an outer core second end 208 opposing the outer core first end 206. The outer core 202 may include a first or upper portion 210 and a second or lower portion 212. The outer core 202 may be capable of transitioning between a first or expanded state (e.g., depicted in FIGS. 4 and 5) and a second or collapsed state (see FIGS. 37 and 38). In some instances, the upper and lower portions 210, 212 may be retained at a distance from one another when the outer core 202 is in the expanded state and the upper and lower portions 210, 212 may contact one another when the outer core 202 is in the collapsed state. In other instances, a distance separating the upper and lower portions 210, 212 may decrease when the outer core 202 transitions from the expanded state to the collapsed state. Transitioning the outer core 202 from the expanded state to the collapsed state may aid a user in removing used ribbon material 134 from the collapsible core assembly 200 (e.g., by reducing a tension applied to the used ribbon material 134).

The upper and lower portions 210, 212 of the outer core 202 may be substantially symmetrical with respect to one another and may each include a portion of an end wall 214 and a spindle arm 216 of the outer core 202. In some instances, the end wall 214 may be positioned at the outer core first end 206, and the spindle arm 216 may be connected to the end wall 214 and extend between the end wall 214 and the outer core second end 208. The spindle arm 216 may be arranged to collect used ribbon material 134 during printing operations. Each of the upper and lower portions 210, 212 may include an outer core channel 218 provided in the form of a substantially linear opening extending entirely through the outer core body 204. The outer core channels 218 may be configured to facilitate a wiping action performed by wipers 220 positioned adjacent to each of the upper and lower portions 210, 212, as explained in detail below with reference to FIGS. 37 and 38.

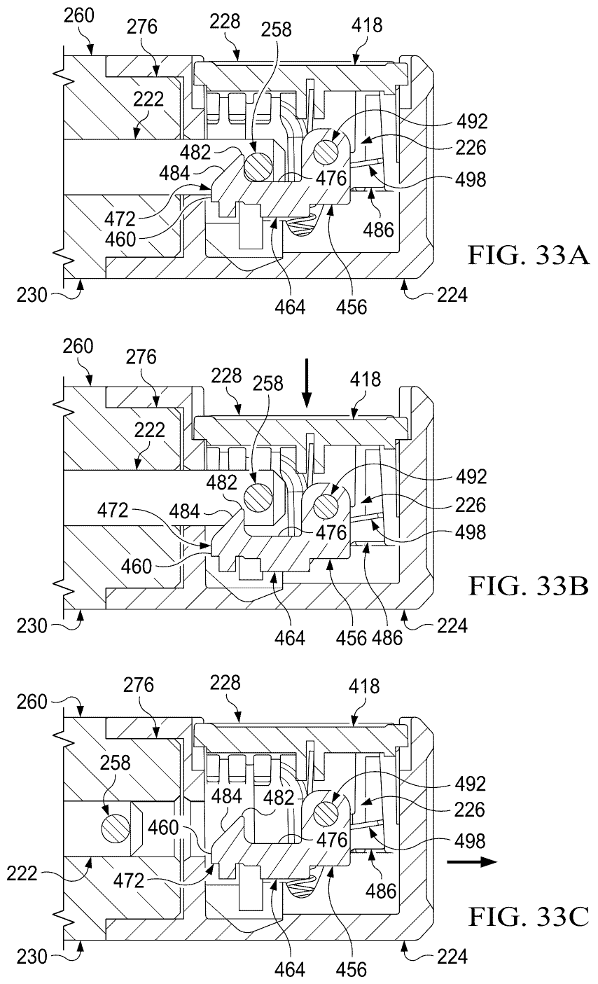

As best shown in the cross-sectional view of FIG. 5, a central shaft 222 may be oriented along a central longitudinal axis A of the collapsible core assembly 200. At least a portion of the shaft 222 may be disposed within the outer core 202. A cap 224 may be positioned adjacent to the outer core second end 208. The cap 224 may house or retain a locking mechanism 226 configured to be operably engaged by a button 228 adjacent to the locking mechanism 226. For example, the button 228 may be operable to release or disengage the locking mechanism 226, as explained in detail below with reference to FIGS. 33A-33C.

The wipers 220 may be coupled to a slider 230 disposed within the outer core 202. In some instances, the wipers 220 are coupled to the slider 230 via fasteners 232. The fasteners 232 may be a screw or any other suitable coupling mechanism known in the art. The slider 230 may partially surround or may be slidably connected to the shaft 222 such that the slider 230 is movable along the shaft 222. For example, the slider 230 may be capable of bi-directional linear motion along the shaft 222 in a direction parallel with the axis A. In some instances, the cap 224 may be coupled to the slider 230 and motion of the slider 230 may be at least partially initiated by disengaging (e.g., releasing) the locking mechanism 226 via the button 228.

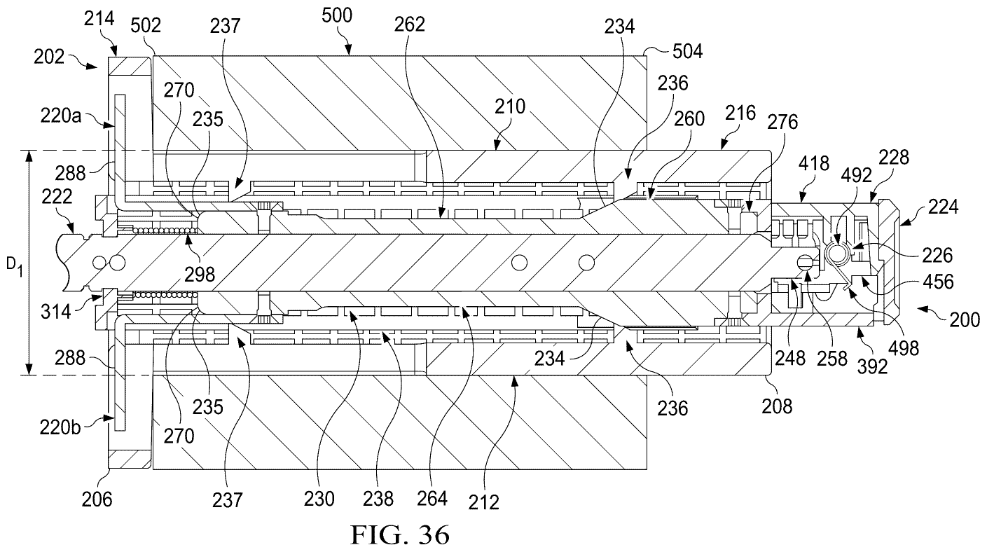

The slider 230 may include one or more first and second ramp surfaces 234, 235 arranged to engage one or more first and second ramp members 236, 237, respectively, connected to the upper and lower portions 210, 212 of the outer core 202. The first and second ramp surfaces 234, 235 of the slider 230 and the first and second ramp members 236, 237 of the outer core 202 may facilitate the transition of the outer core 202 between the expanded state and the collapsed state, as explained in detail below with reference to FIGS. 36-38.

The collapsible core assembly 200 may include an inner core 238 disposed within the outer core 202 and at least partially surrounding the shaft 222. In some instances, the inner core 238 may be configured to support or guide other internal components of the collapsible core assembly 200 or to impart structural rigidity and/or stability to the collapsible core assembly 200 as a whole.

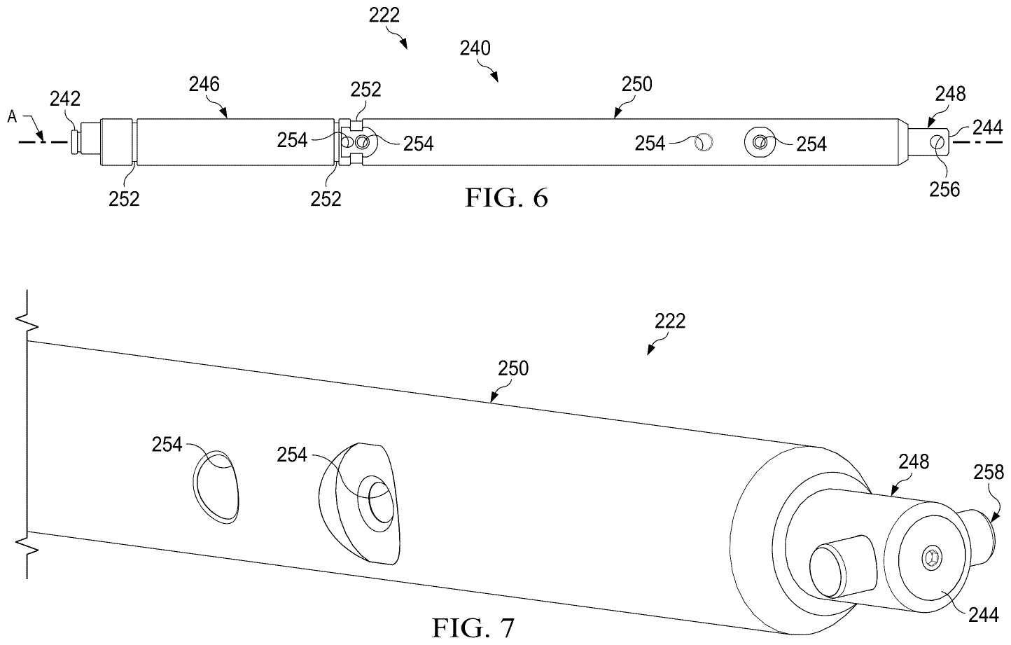

Turning to FIG. 6, the shaft 222 may be provided in the form of a substantially cylindrical shaft body 240 extending between a shaft first end 242 and a shaft second end 244. In some instances, the shaft body 240 may include a mounting region 246 proximate to the shaft first end 242, a stud 248 proximate to the shaft second end 244, and a main body portion 250 positioned between the mounting region 246 and the stud 248. The shaft 222 may include one or more shaft grooves 252 disposed along the shaft body 240 and one or more shaft connection holes 254 disposed along the shaft body 240 and extending either partially or entirely therethrough. In some instances, the shaft grooves 252 and/or the shaft connection holes 254 may facilitate attachment between the shaft 222 and other components of the collapsible core assembly 200.

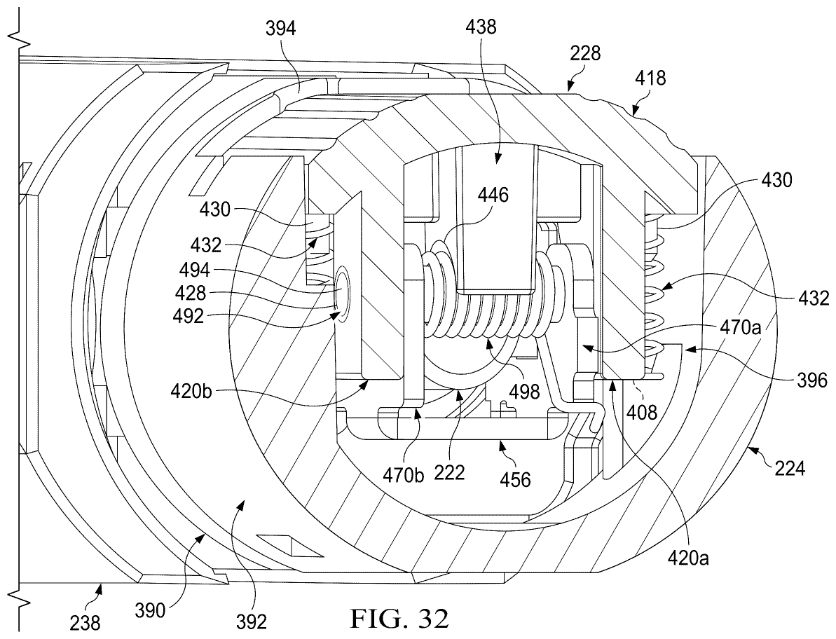

The mounting region 246 may be designed to facilitate installation of the collapsible core assembly 200 in a printing device (e.g., by facilitating attachment of the collapsible core assembly 200 to the mounting wall 120 of the printer 100). The stud 248 may be designed to extend at least partially into the cap 224 when the outer core 202 is in the expanded state (see, e.g., FIG. 5) and facilitate engagement between the shaft 222 and the locking mechanism 226. For example, the stud 248 may include a stud pin hole 256 provided in the form of a substantially circular opening extending entirely through the stud 248 in a direction perpendicular to the axis A. As best shown in FIG. 7, the stud pin hole 256 may receive and retain a first pin member 258 configured to releasably engage the locking mechanism 226 as described in detail below with reference to FIG. 32. In some instances, the first pin member 258 may be secured within the stud pin hole 256 via a screw, a set screw, or any other suitable fastener (not shown).

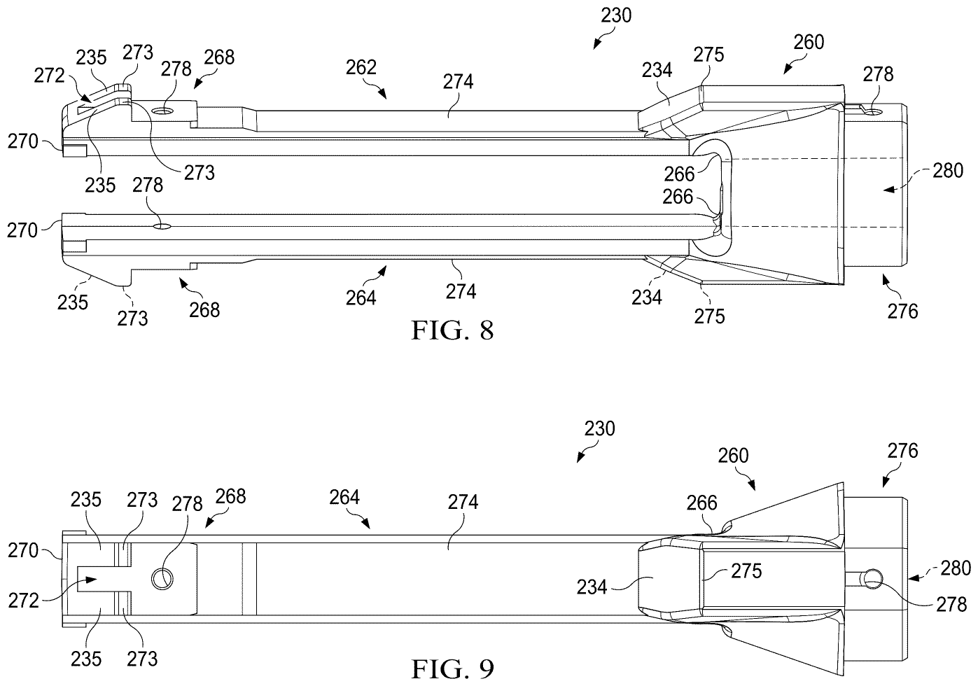

Turning now to FIGS. 8-10, the slider 230 may be provided in the form of a substantially annular hub region 260, a first or upper arm 262 connected to the hub region 260 and extending outwardly therefrom, and a second or lower arm 264 connected to the hub region 260 and extending outwardly therefrom. In some instances, the upper and lower arms 262, 264 of the slider 230 may be substantially symmetrical; for example, the shape and structure of the upper arm 262 may mirror the shape and structure of the lower arm 264. A proximal end 266 of each of the upper and lower arms 262, 264 may be either formed integrally with or coupled to the hub region 260. Each of the upper and lower arms 262, 264 may include a stepped end region 268 at a distal end 270 thereof (e.g., positioned opposite the proximal end 266).

As mentioned above, the slider 230 may include one or more first ramp surfaces 234 and one or more second ramp surfaces 235 designed to engage one or more first ramp members 236 and one or more second ramp members 237, respectively, of the outer core 202. In some instances, the upper and lower arms 262, 264 may each include a first ramp surface 234 proximate to the hub region 260 and two second ramp surfaces 235 positioned on the end region 268. The second ramp surfaces 235 of each of the upper and lower arms 262, 264 may be substantially parallel and coplanar with respect to one another and may be separated by a rectilinear wiper slot 272 extending therebetween. Each of the second ramp surfaces 235 may extend away from the distal end 270 at an angle and terminate at a second ramp surface summit 273 of the second ramp surface 235. Similarly, the first ramp surface 234 may terminate at a first ramp surface summit 275 positioned proximate to the hub region 260.

The upper and lower arms 262, 264 may each include a trough 274 provided in the form of a substantially smooth or flat surface extending between the end region 268 and the first ramp surface 234. The slider 230 may include a substantially annular insert 276 positioned opposite the upper and lower arms 262, 264 with respect to the hub region 260. The insert 276 may be formed integrally with or coupled to the hub region 260 and extend outwardly therefrom (e.g., in a direction parallel to the direction of extension of the upper and lower arms 262, 264). In some instances, the slider 230 may include one or more slider connection holes 278 configured to facilitate coupling between the slider 230 and other components of the collapsible core assembly 200. The slider connection holes 278 may be positioned on the upper arm 262, lower arm 264, hub region 260, and/or insert 276.

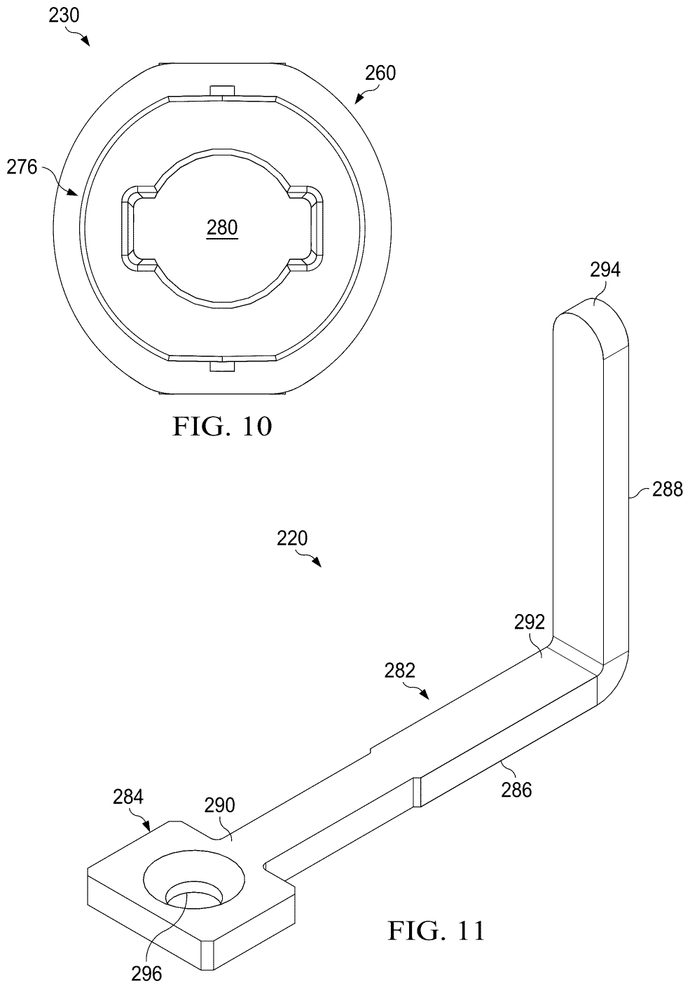

As best shown in FIG. 9, in some instances, the hub region 260 may be imparted with a conical or frustoconical shape and the insert 276 may be imparted with a substantially cylindrical shape. In other instances, the hub region 260 and the insert 276 may be imparted with any suitable shape or structure. As best shown in FIG. 10, a slider opening 280 configured to receive the shaft 222 may extend entirely through each of the hub region 260 and the insert 276. In some instances, the slider opening 280 may be substantially circular. In other instances, the slider opening 280 may be imparted with any suitable shape provided that the slider opening 280 is configured to receive a portion of the shaft 222.

Turning to FIG. 11, each wiper 220 may be provided in the form of a substantially rectilinear or elbow-shaped wiper body 282 including a connection tab 284, a base member 286, and a wiping member 288. The connection tab 284 may be connected to a base member first end 290 and may be oriented substantially coplanar with the base member 286. The wiping member 288 may be connected to a base member second end 292 and may be oriented at an angle with respect to the base member 286. For example, the wiping member 288 may be substantially perpendicular with respect to the base member 286. The wiping member 288 may terminate at an apex 294 thereof positioned opposite the base member second end 292. The connection tab 284 may include a wiper connection hole 296 provided in the form of a substantially circular opening extending entirely therethrough and configured to facilitate coupling between the wiper 220 and the slider 230.

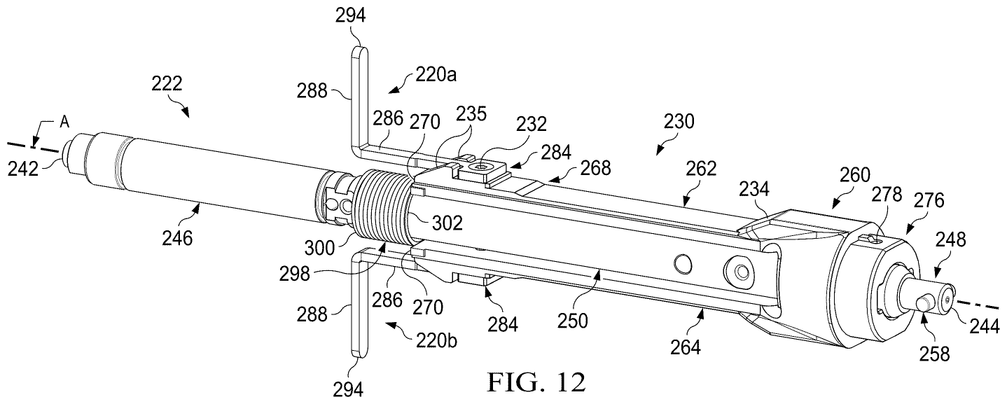

As shown in FIG. 12, the slider 230 may be disposed along the shaft 222 when the collapsible core assembly 200 is assembled. In some instances, two wipers 220 may be installed on the slider 230. In some instances, a first wiper 220a may be coupled to the upper arm 262 and a second wiper 220b may be coupled to the lower arm 264 via the fasteners 232 extending through the wiper connection holes 296 and the slider connection holes 278 positioned on the stepped end regions 268 of each of the upper and lower arms 262, 264 (see FIG. 8). The base member 286 of the wipers 220 may be received by and positioned within the wiper slot 272 (see FIGS. 8 and 9) between the second ramp surfaces 235.

The slider opening 280 may receive the shaft 222 such that the upper and lower arms 262, 264 partially surround the main body portion 250 of the shaft 222 and the stud 248 (including the first pin member 258) extends through the insert 276 of the slider 230. In some instances, the stud 248 and the first pin member 258 extend beyond the insert 276 of the slider 230 such that the stud 248 and the first pin member 258 are positioned within the cap 224 proximate to the locking mechanism 226 (see FIG. 5) when the collapsible core assembly 200 is assembled. The configuration depicted in FIG. 12 may reflect the position of the slider 230 relative to the shaft 222 when the outer core 202 is in the expanded state (see, e.g., FIGS. 4 and 5).

When the slider 230 and wipers 220 are installed along the shaft 222, each base member 286 of the wipers 220a, 220b may be substantially parallel with respect to the axis A and each wiping member 288 may extend away from the shaft 222 in a direction substantially perpendicular with respect to the axis A. In some instances, the wiping members 288 may extend beyond the upper and lower portions 210, 212 of the outer core 202 via the outer core channels 218 (see FIG. 5) and thus be positioned to aid in the removal of used ribbon material 134 from the collapsible core assembly 200.

A spring 298 may be positioned along the shaft 222 and configured to apply an outward force to the slider 230 (e.g., the spring 298 may bias the slider 230 toward movement in the direction of the shaft second end 244). For example, when the outer core 202 is in the expanded state, the spring 298 may be compressed. In some instances, a spring first end 300 of the spring 298 may be supported or immobilized by the inner core 238 and/or other adjacent components of the collapsible core assembly 200 (see FIG. 5). A spring second end 302 opposing the spring first end 300 may be in contact with the slider 230 (e.g., via the distal ends 270 of each of the upper and lower arms 262, 264). Thus, the spring 298 may apply an outward force to the slider 230 (e.g., via the clastic potential energy of the spring 298).

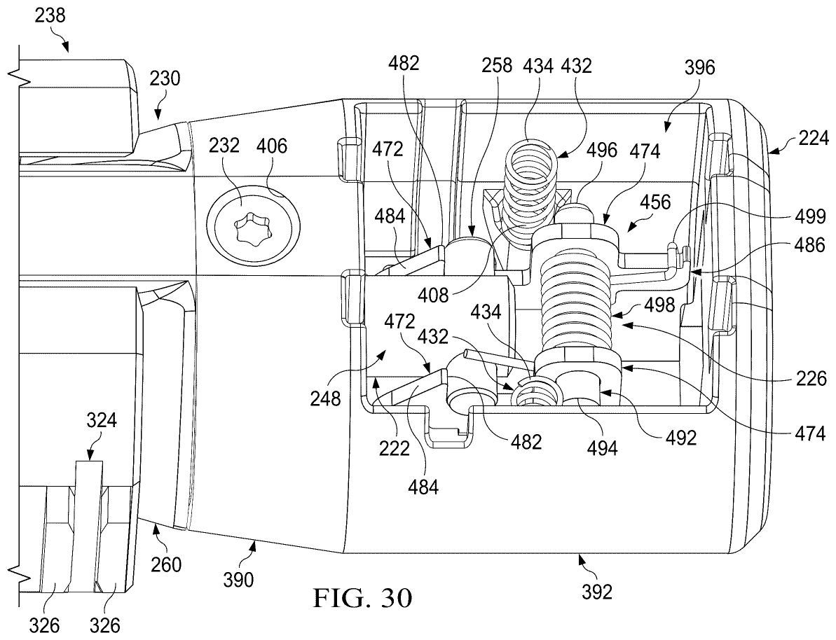

As described in more detail below with reference to FIG. 30, the first pin member 258 may engage the locking mechanism 226 and prevent the slider 230 from moving along the shaft 222 in response to the force applied by the spring 298. However, when the locking mechanism 226 disengages the first pin member 258 (e.g., due to a user pressing the button 228), the spring 298 may generate, or contribute to the generation of, motion of the slider 230 in the direction of the shaft second end 244.

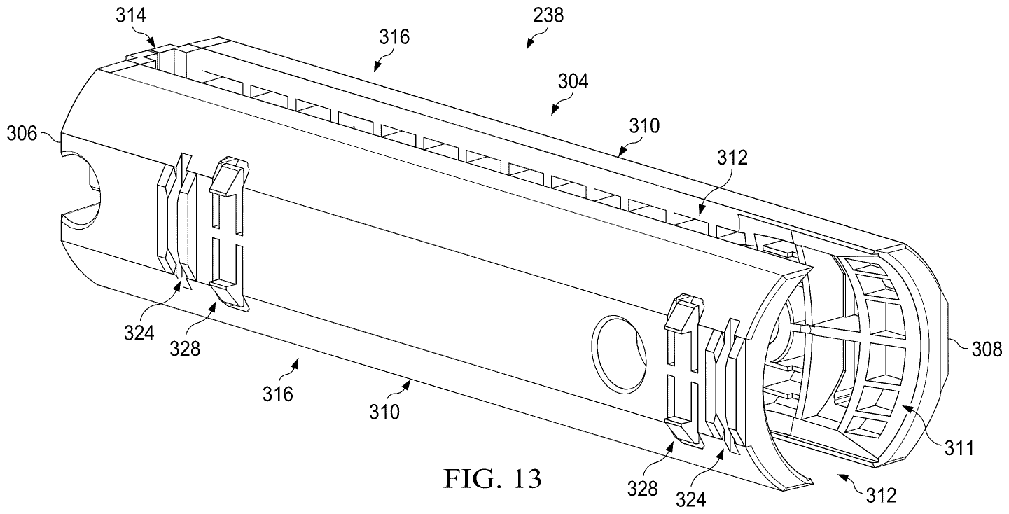

Turning to FIGS. 13-16, the inner core 238 may be provided in the form of a substantially tubular inner core body 304 defined by an inner core first end 306 and an inner core second end 308 opposing the inner core first end 306. The inner core 238 may include two rounded sidewalls 310 extending between the inner core first end 306 and the inner core second end 308. The sidewalls 310 may be configured to partially surround at least a portion of the shaft 222 and slider 230. For example, a substantially circular gap 311 disposed between the two sidewalls 310 at the inner core second end 308 may be configured to receive the hub region 260 of the slider 230. In some instances, two rectilinear inner core channels 312 may extend between the inner core first end 306 and the inner core second end 308 and may separate the two sidewalls 310. In some instances, the inner core channels 312 may be disposed substantially parallel to one another. In some instances, the inner core channels 312 may be configured to permit the wipers 220 to move freely with respect to the inner core 238 while the collapsible core assembly 200 is in operation. Furthermore, each sidewall 310 may be connected to a backplate 314 positioned at the inner core first end 306 and extend outwardly therefrom.

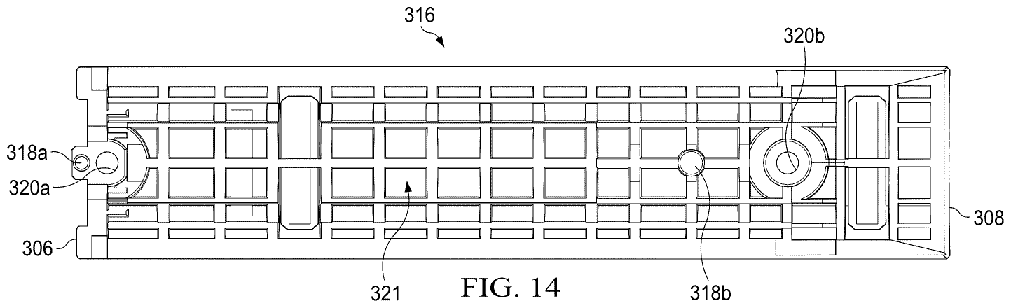

In some instances, the inner core 238 may be provided in the form of two half portions 316 that may be independently coupled to the shaft 222. As best shown in FIG. 14, each half portion 316 may have one or more notches 318 and one or more inner core connection holes 320 positioned on an inner core interior surface 321. For example, each half portion 316 may include a first notch 318a and a first inner core connection hole 320a proximate to the inner core first end 306 (e.g., adjacent to the backplate 314) and a second notch 318b and a second inner core connection hole 320b proximate to the inner core second end 308. In other instances, each half portion 316 may include any number of notches 318 and inner core connection holes 320 positioned in any suitable arrangement. In some instances, one or more of the shaft connection holes 254 may be configured to securely receive the notches 318 (e.g., in a press or friction fit). Additionally, one or more of the shaft connection holes 254 may be configured to align with the inner core connection holes 320 and receive a fastener (e.g., via a threaded inner surface), thereby coupling the half portion 316 to the shaft 222.

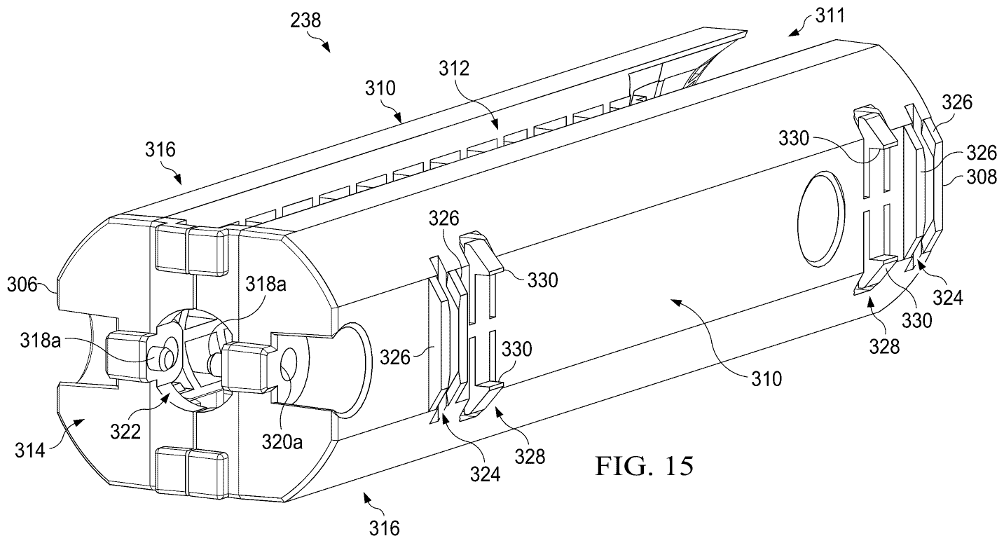

As best shown in FIG. 15, the backplate 314 may define a substantially circular backplate opening 322 extending entirely therethrough. The backplate opening 322 may be configured to receive or to be received by a portion of the shaft 222. In some instances, the backplate opening 322 may align with and be received by the shaft groove 252 proximate to the main body portion 250 of the shaft 222 (see FIG. 6). In other instances, the inner core 238 may be installed on the shaft 222 in any suitable manner. Whereas the slider 230 may be movable with respect to the shaft 222, the inner core 238 may be configured to remain stationary with respect to the shaft 222 during operation of the collapsible core assembly 200.

Each of the sidewalls 310 of the inner core 238 may include one or more guide members 324 and/or one or more bumpers 328 configured to facilitate a connection between the inner core 238 and the outer core 202. The guide members 324 may be designed to receive or anchor a portion of the outer core 202. For example, as best shown in FIG. 15, the guide members 324 may be provided in the form of two parallel, rectilinear ridges 326 arranged to retain a portion of the outer core 202 therebetween. Thus, the guide members 324 may be designed to restrict or prevent the outer core 202 from moving with respect to the inner core 238 (e.g., in a direction parallel to the axis A).

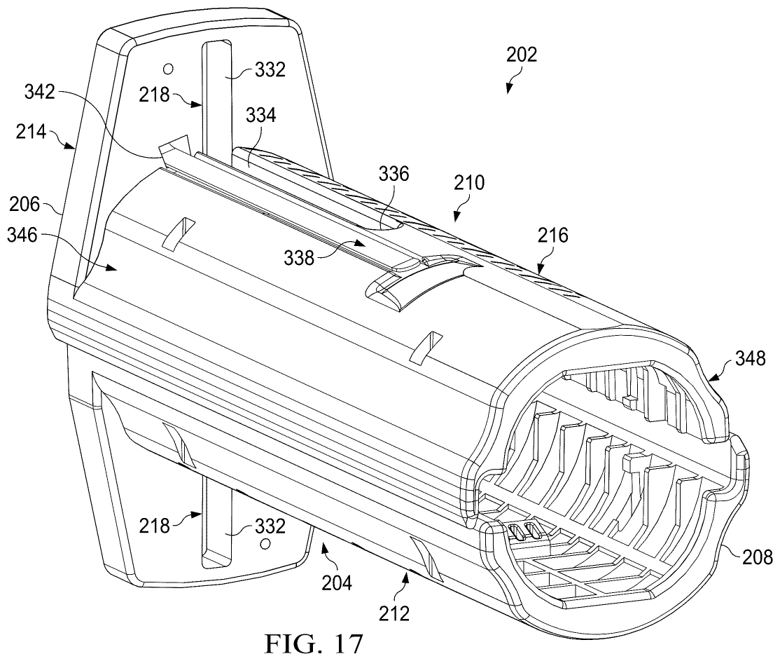

The bumpers 328 may be designed to engage a portion of the outer core 202. For example, the bumper 328 may be provided in the form of two opposing hook members 330 (e.g., one of the hook members 330 may be arranged to engage a portion of the upper portion 210 of the outer core 202 and the other hook member 330 may be arranged to engage a portion of the lower portion 212). Thus, the bumpers 328 may be configured to prevent the upper and lower portions 210, 212 of the outer core 202 (see FIG. 17) from disassembling (e.g., moving away from each other in a direction perpendicular to the axis A) beyond what is necessary for the outer core 202 to transition between the expanded state and the collapsed state.

In some instances, each sidewall 310 of the inner core 238 may include (i) one guide member 324 and one bumper 328 proximate to the inner core first end 306, and (ii) one guide member 324 and one bumper 328 proximate to the inner core second end 308. In other instances, the inner core 238 may include any number of guide members 324 and/or bumpers 328 arranged in any suitable configuration. In yet other instances, the guide members 324 and the bumpers 328 may be omitted and the outer core 202 may be connected and oriented with respect to the inner core 238 in any suitable manner.

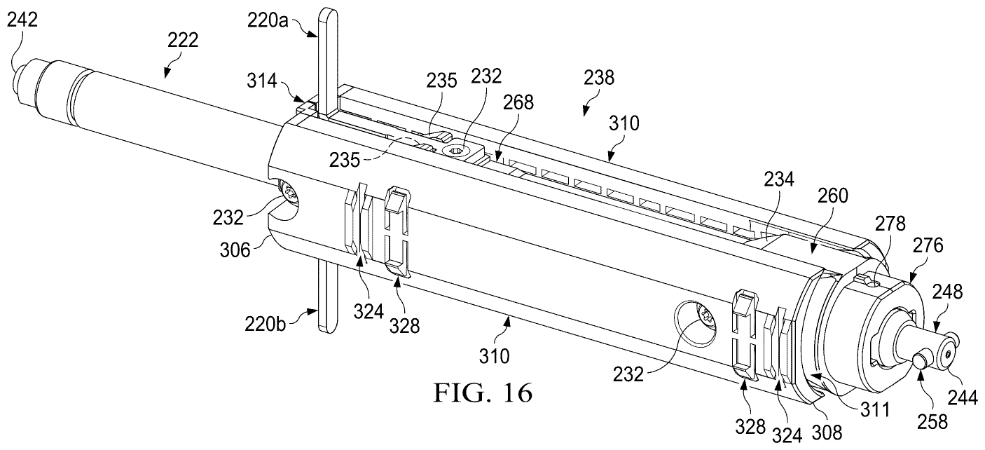

As best shown in FIG. 16, the inner core 238 may be installed on the shaft 222 (e.g., by fasteners 232). The wipers 220 may be positioned between the sidewalls 310 such that the wipers 220 are free to move through the inner core channels 312 when the slider 230 moves along the shaft 222. Additionally, the first and second ramp surfaces 234, 235 of the slider 230 may be positioned within the inner core channels 312 such that the first ramp surfaces 234 are available for engagement with the first ramp members 236 of the outer core 202 and the second ramp surfaces 235 are available for engagement with the second ramp members 237 of the outer core 202 (see FIG. 36). The hub region 260 may be positioned within the gap 311 at the inner core second end 308. The insert 276 may extend beyond the inner core second end 308 such that the cap 224 may be coupled thereto, and the stud 248 of the shaft 222 may extend beyond the insert 276 such that the first pin member 258 is available for engagement with the locking mechanism 226.

Turning to FIG. 17, the upper and lower portions 210, 212 of the outer core 202 may together form the end wall 214 and the spindle arm 216 of the outer core 202. The outer core channels 218 formed in each of the upper portion 210 and the lower portion 212 may be provided in the form of substantially linear channels or carve outs extending entirely through a portion of the outer core body 204. The position of the two outer core channels 218 along the spindle arm 216 may be directly opposite one another (e.g., separated by) 180° such that they are arranged to align with the wipers 220 attached to the slider 230 (see FIG. 16). Each outer core channel 218 may include an upright portion 332 positioned on the end wall 214 and a wiper path 334 extending along the spindle arm 216 at least part of the way to the outer core second end 208. The wiper path 334 may terminate at a terminal end 336 thereof positioned on the spindle arm 216.

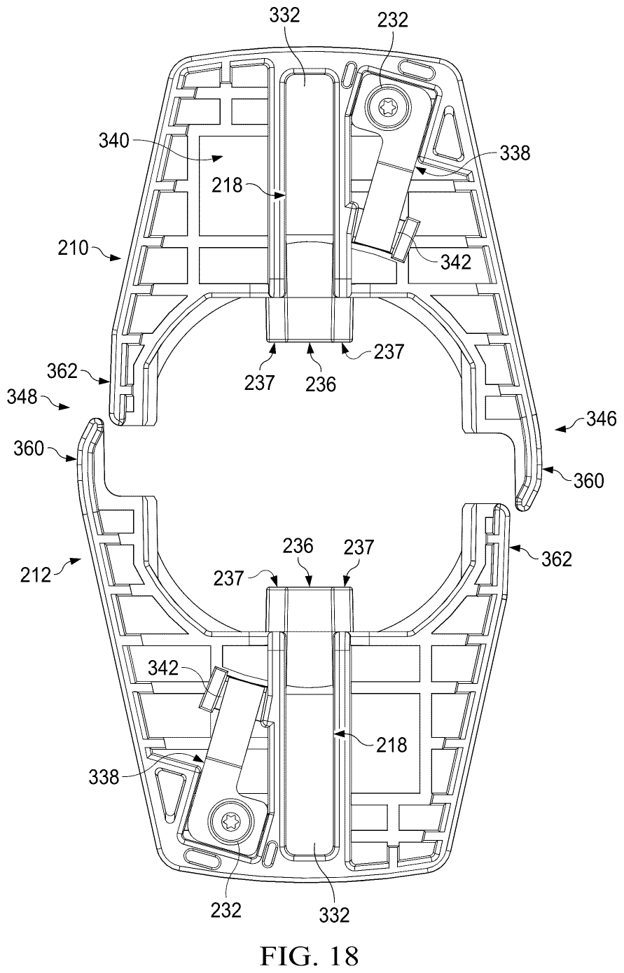

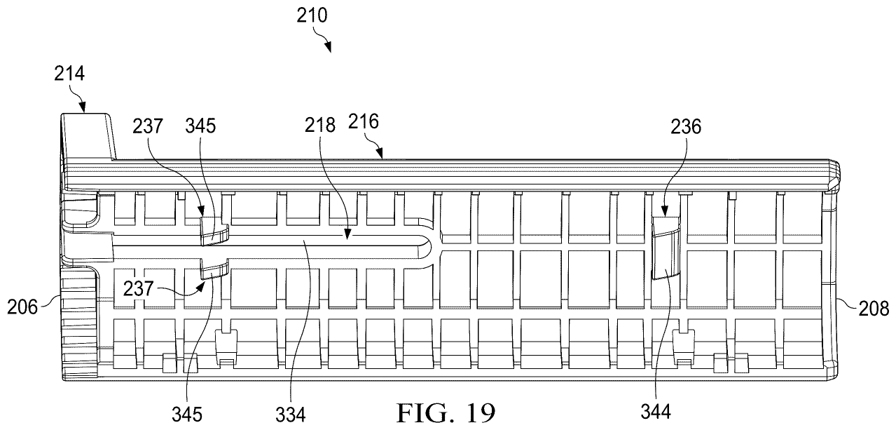

In some instances, a retention member 338 may be installed on each of the upper portion 210 and the lower portion 212. The retention members 338 may extend along at least a portion of the spindle arm 216 and may be arranged to be substantially flush with the spindle arm 216. As best shown in FIG. 18, the retention members 338 may be coupled to a rear face 340 of the end wall 214 via a fastener 232. The retention members 338 may extend through the end wall 214 via an aperture 342 positioned proximate to the upright portion 332 of the outer core channel 218. In some instances, the retention members 338 may aid a user in installing ribbon material 134 in a printing device (e.g., the printer 100). For example, a new ribbon roll 136 may be installed on the ribbon supply spindle 130 (see FIG. 3) and at least a portion of the ribbon material 134 from the ribbon roll 136 may be guided along the desired ribbon path and interposed between the outer core 202 and the retention members 338. The retention members 338 may apply a pressure (e.g., a pinching force) such that a portion of the ribbon material 134 is held in place against the outer core 202. In this way, the ribbon material 134 may be secured along the ribbon path and arranged for collection on the collapsible core assembly 200 while the printing device is in use.

Turning to FIGS. 19-21, the upper portion 210 and the lower portion 212 of the outer core 202 may each include one or more first ramp members 236 and one or more second ramp members 237 connected to spindle arm 216 and extending inwardly therefrom. The first ramp members 236 may be arranged for engagement with the first ramp surfaces 234 of the slider 230. As shown best in FIG. 19, in some instances, the upper and lower portions 210, 212 may each include a first ramp member 236 (e.g., arranged to engage the first ramp surface 234) and two second ramp members 237 (e.g., arranged to engage the second ramp surfaces 235). The first ramp member 236 may be positioned proximate to the outer core second end 208. The second ramp members 237 of the upper portion 210 and the second ramp members 237 of the lower portion 212 may be substantially parallel and coplanar with respect to one another and may be positioned in opposing locations adjacent to the associated wiper path 334. The first ramp member 236 may include a first sloped surface 344 designed to mate with or complement the first ramp surface 234, and the second ramp members 237 may each include a second sloped surface 345 designed to mate with or complement the second ramp surfaces 235.

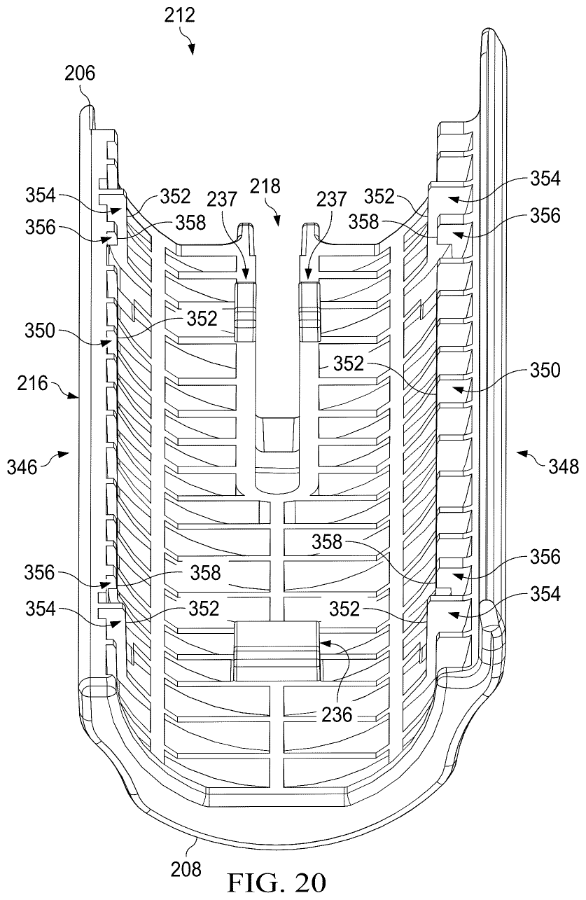

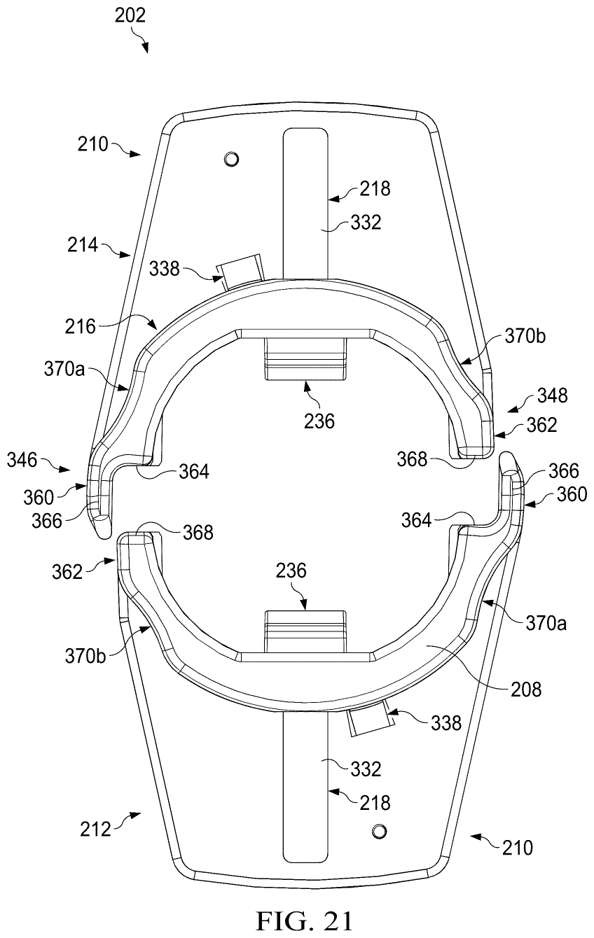

As best shown in FIGS. 20 and 21, the spindle arm 216 may be defined by a spindle arm first side 346 and a spindle arm second side 348 opposing the spindle arm first side 346. The upper portion 210 and lower portion 212 of the outer core 202 may each include a plurality of support walls 350 arranged along the spindle arm first side 346 and the spindle arm second side 348 and extending inwardly therefrom (e.g., support walls 350 connected to the spindle arm first side 346 may extend toward the spindle arm second side 348 and vice versa). The support walls 350 may be provided in the form of substantially rectilinear panels connected including a substantially vertical inner edge 352 positioned within the spindle arm 216 (e.g., the inner edges 352 may be designed to contact and/or support the sidewalls 310 of the inner core 238).

In some instances, upper and lower portions 210, 212 may each include one or more guide walls 354 and one or more notched walls 356 configured to facilitate a connection between the outer core 202 and the inner core 238. In some instances, the guide walls 354 may be provided in substantially the same form as the support walls 350, except the guide walls 354 may extend further into the interior of the spindle arm 216 than the support walls 350. For example, the guide walls 354 connected to the spindle arm second side 348 may include an inner edge 352 positioned closer to the spindle arm first side 346 than the inner edge 352 of the support walls 350. The guide walls 354 may be arranged to be received between the ridges 326 of the guide members 324 of the inner core 238. Thus, engagement between the guide walls 354 and adjacent ridges 326 may prevent the outer core 202 from substantially moving or tracking with respect to the inner core 238.

The notched walls 356 may be provided in substantially the same form as the support walls 350, except the notched walls 356 may include a notched edge 358 in place of the substantially vertical inner edge 352 of the support walls 350. The notched wall 356 may facilitate a connection between the outer core 202 and the inner core 238 via engagement between the notched edge 358 and the hook members 330 of the bumpers 328. For example, one hook member 330 of one of the bumpers 328 may engage a notched wall 356 connected to the upper portion 210 and the other hook member 330 of the bumper 328 may engage a notched wall 356 connected to the lower portion 212. Thus, while the upper and lower portions 210, 212 may be designed to move closer to or farther from one another when the outer core 202 transitions between the expanded state and the collapsed state, the bumpers 328 may prevent the upper and lower portions 210, 212 from moving too far from one another such that the outer core 202 disassembles or otherwise impedes the operation of the collapsible core assembly 200.

In some instances, the upper portion 210 and the lower portion 212 of the outer core 202 may each have a pair including one guide wall 354 and one notched wall 356 connected to (i) the spindle arm first side 346 proximate to the outer core first end 206, (ii) the spindle arm first side 346 proximate to the outer core second end 208, (iii) the spindle arm second side 348 proximate to the outer core first end 206, and (iv) the spindle arm second side 348 proximate to the outer core second end 208. In other instances, the outer core 202 may include any number of guide walls 354 and notched walls 356 positioned in any suitable arrangement, provided that the guide walls 354 and notched walls 356 are arranged to align with the guide members 324 and the bumpers 328, respectively, and facilitate a connection between the outer core 202 and inner core 238. In still other instances, the outer core 202 may include any additional or alternative components designed to align with complementary components of the inner core 238 and facilitate a connection thereto.

As best shown in FIG. 21, the upper portion 210 and the lower portion 212 may be imparted with complementary structures designed to facilitate a transition of the outer core 202 between the expanded state and the collapsed state. FIG. 21 depicts the outer core 202 in the expanded state. In some instances, the upper and lower portions 210, 212 may each include a seat member 360 and a peg member 362. The seat members 360 may include a receiving surface 364 and a substantially linear finger 366 extending outwardly therefrom (e.g., in the direction of the adjacent peg member 362). The peg members 362 may include an end surface 368 configured to abut or to be received by the receiving surface 364 of the adjacent seat member 360. For example, the receiving surface 364 and the end surface 368 may each be provided in the form of a substantially planar surface and may be oriented parallel with respect to one another. The structure of the seat members 360 and the peg members 362 as depicted in FIG. 21 may be consistent along the length of the spindle arm 216 (e.g., the seat members 360 and peg members 362 may extend between the end wall 214 and the outer core second end 208 along the length the spindle arm 216).

When the outer core 202 is in the collapsed state, the seat members 360 may receive the adjacent peg members 362 such that the receiving surfaces 364 abut or are adjacent to the end surfaces 368 and the peg members 362 are positioned adjacent to (e.g., inside) the fingers 366 of the seat members 360 (see FIG. 38). For example, the seat member 360 of the upper portion 210 may be arranged to receive the peg member 362 of the lower portion 212, and the seat member 360 of the lower portion 212 may be arranged to receive the peg member 362 of the upper portion 210. In some instances, the upper portion 210 may include the seat member 360 at the spindle arm first side 346 and the peg member 362 at the spindle arm second side 348. In those instances, the lower portion 212 may include the peg member 362 at the spindle arm first side 346 and the seat member 360 at the spindle arm second side 348. In other instances, the seat members 360 and peg members 362 of the upper and lower portions 210, 212 may be provided in a reverse configuration.

Referring still to FIG. 21, the outer core 202 may include one or more removal grooves 370 positioned about the spindle arm 216 and extending linearly between the end wall 214 and the outer core second end 208. In some instances, the upper portion 210 and the lower portion 212 may each include a first removal groove 370a proximate to the seat member 360 and a second removal groove 370b proximate to the peg member 362 and positioned substantially opposite the first removal groove 370a. In other instances, the outer core 202 may include any number of removal grooves 370 positioned on the upper portion 210 and/or the lower portion 212 in any suitable arrangement. The removal grooves 370 may aid a user in removing used ribbon material 134 from the spindle arm 216 as described in detail below with reference to FIG. 38. For example, the removal grooves 370 may be provided in the form of curved indentations configured to support and/or guide a finger or thumb of a user along the spindle arm 216.

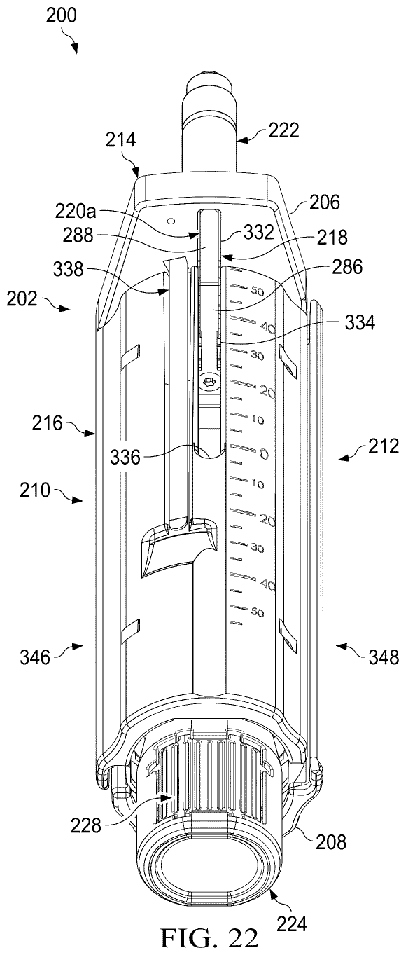

As shown in FIG. 22, the outer core 202 may be installed on the partial assembly shown in FIG. 16 such that the outer core 202 at least partially surrounds the inner core. The first wiper 220a may be positioned within the outer core channel 218 of the upper portion 210 of the outer core 202 such that the first wiper 220a may move along the spindle arm 216 in the direction of the outer core second end 208 during operation of the collapsible core assembly 200. The second wiper 220b (not shown) may similarly be positioned within the outer core channel 218 of the lower portion 212 of the outer core 202 such that the second wiper 220b may also move along the spindle arm 216 in the direction of the outer core second end 208 during operation of the collapsible core assembly 200. When the outer core 202 is in the expanded state, the wiping member 288 of the wipers 220 may be disposed within the upright portion 332 of the outer core channel 218. When the outer core 202 transitions from the expanded state to the collapsed state, the wiping member 288 of the wipers 220 may extend beyond the spindle arm 216 and may be free to move along a portion thereof via the wiper path 334.

When the collapsible core assembly 200 is in the expanded state, at least a portion of the shaft 222 may extend beyond the outer core first end 206, and at least a portion of the cap 224 may extend beyond the outer core second end 208. For example, the button 228 may be positioned outside of the spindle arm 216 (e.g., beyond the outer core second end 208) such that the button 228 is available to a user when the outer core 202 is in the expanded state (as shown in FIG. 22).

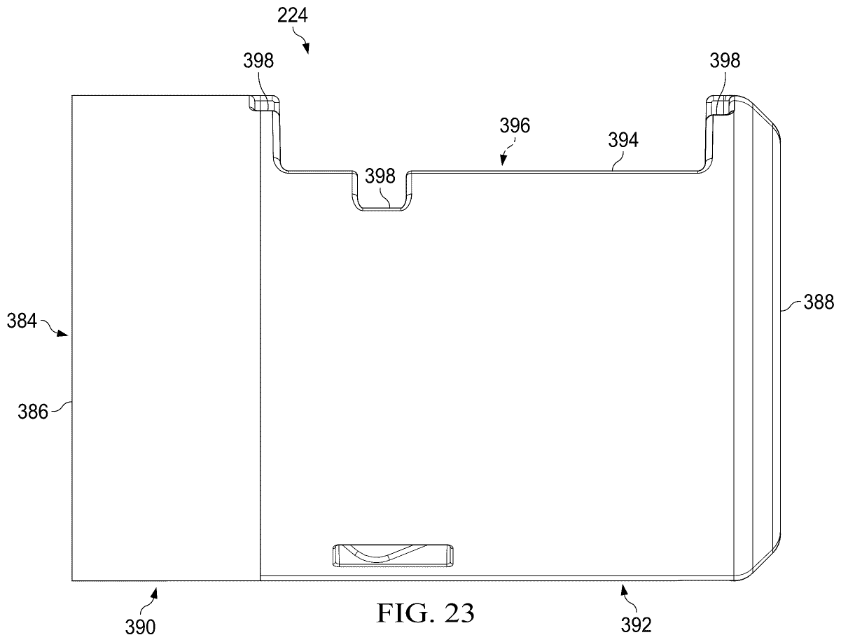

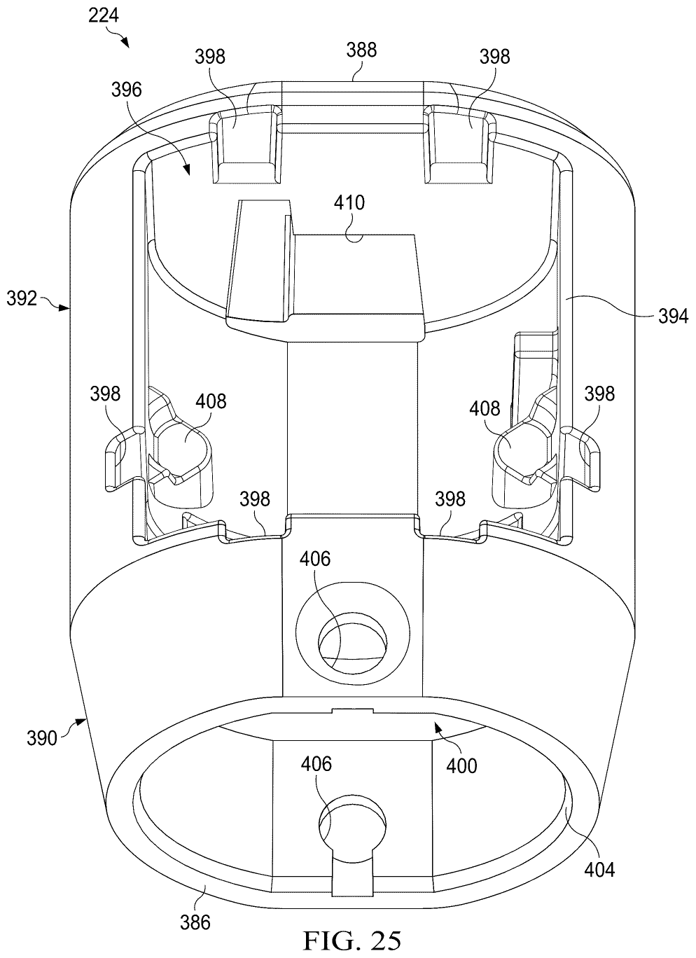

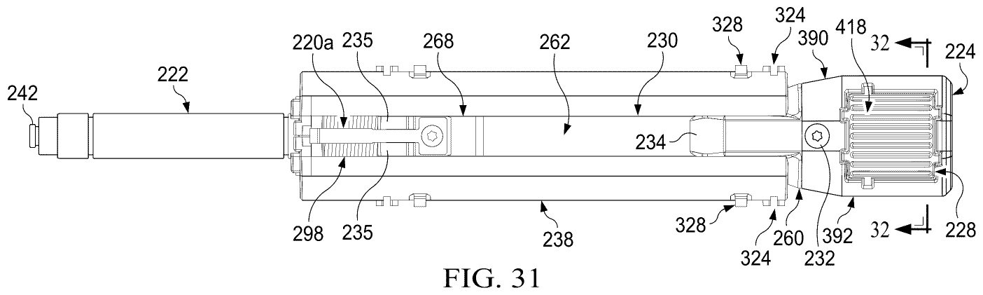

Turning to FIGS. 23-25, the cap 224 may be provided in the form of a substantially cylindrical cap body 384 defined by a cap first end 386 and a cap second end 388 opposing the cap first end 386. The cap 224 may include a connection region 390 proximate to the cap first end 386 designed to receive the insert 276 of the slider 230 and facilitate coupling between the cap 224 and the slider 230. The cap 224 may further include a housing 392 positioned between the connection region 390 and the cap second end 388. The housing 392 may include an upper perimeter 394 defining an opening to a cavity 396 disposed within the housing 392 (see FIG. 25). The cavity 396 may be configured to support and retain the locking mechanism 226, and the upper perimeter 394 may be designed to receive the button 228 or otherwise facilitate a connection between the cap 224 and the button 228. For example, one or more indentations 398 may be disposed along the upper perimeter 394 and configured to receive a portion of the button 228 (see FIG. 31).

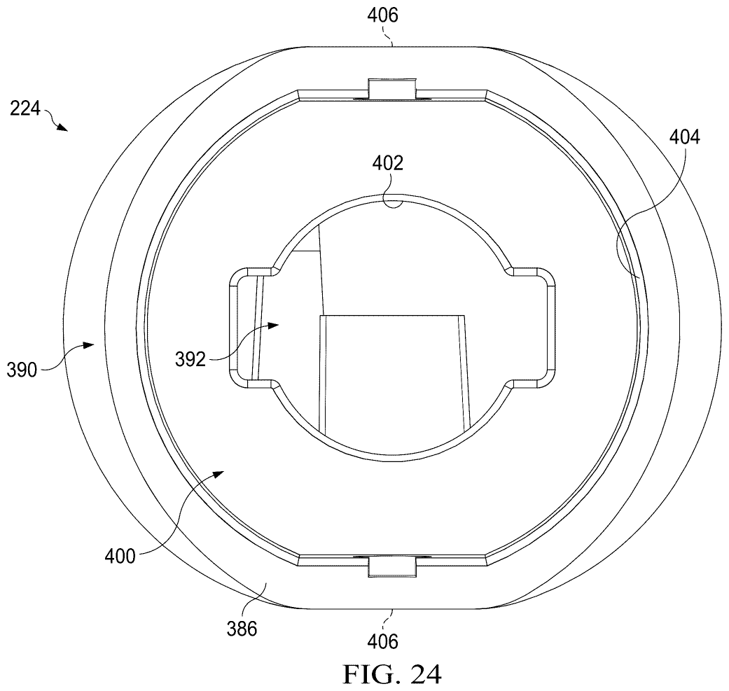

As best shown in FIG. 24, the connection region 390 and housing 392 may be separated by a partition 400. The partition 400 may be provided in the form of a substantially flat panel or wall with a cutout 402 provided in the form of an opening between the connection region 390 and the housing 392. The cutout 402 may be configured to allow the stud 248 (and the first pin member 258) to extend therethrough such that the stud 248 is disposed within the cavity 396. The connection region 390 may be defined by an inner diameter 404 that mirrors or complements the structure of the insert 276 of the slider 230. Thus, the connection region 390 may receive the insert 276 and may facilitate coupling the cap 224 to the slider 230. For example, one or more cap connection holes 406 disposed on the connection region 390 (see FIG. 25) may align with one or more slider connection holes 278 disposed on the insert 276 (see FIG. 16) such that a fastener 232 may extend therethrough (see FIGS. 30 and 31).

As best shown in FIG. 25, in some instances, the connection region 390 may include two cap connection holes 406, and the insert 276 may include two slider connection holes 278 configured to align with the cap connection holes 406. One or more spring platforms 408 may be positioned within the cavity 396 defined by the upper perimeter 394 of the housing 392. For example, the spring platforms 408 may be positioned in opposing locations adjacent to the upper perimeter 394. The housing 392 may also include a ledge 410 arranged to be engaged by at least a portion of the button 228, thereby facilitating a connection between the cap 224 and the button 228.

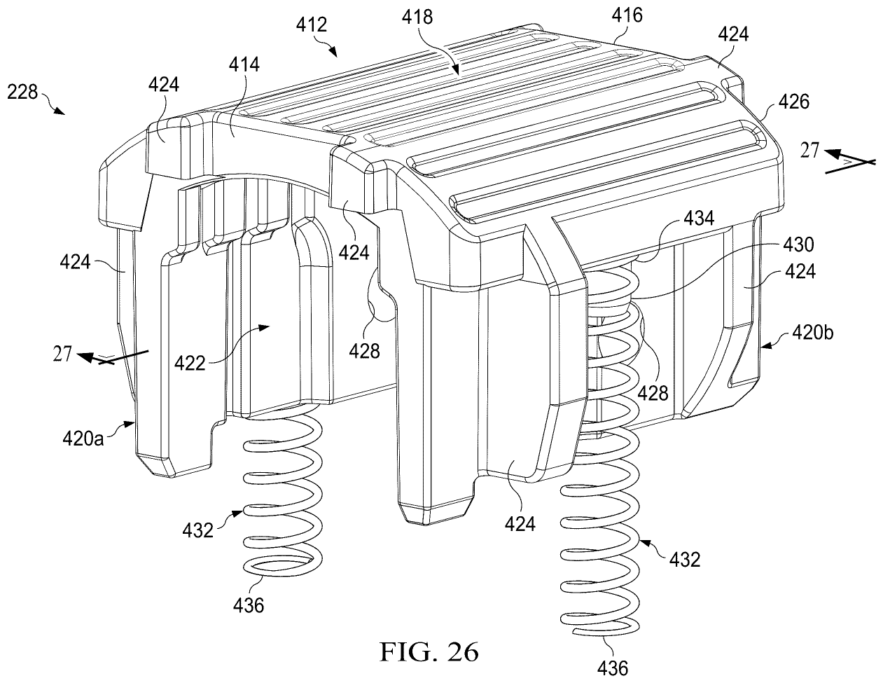

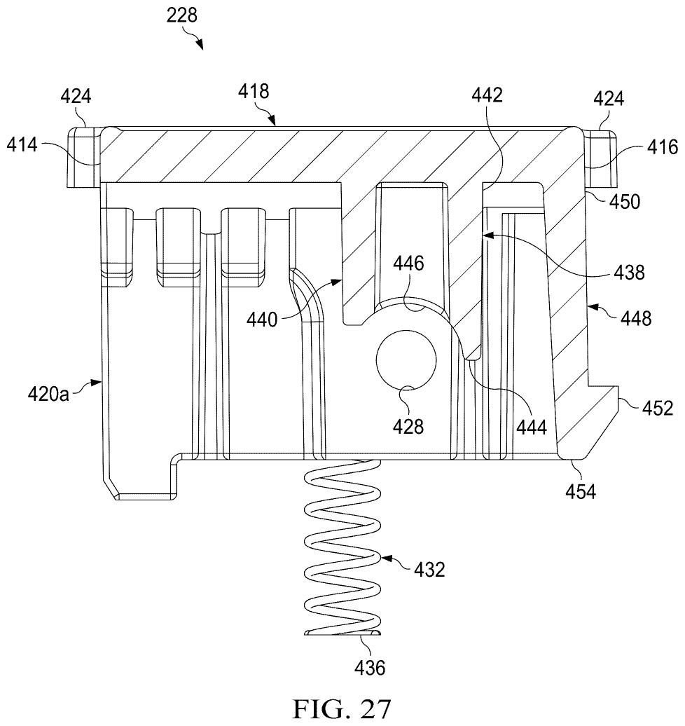

Turning now to FIGS. 26 and 27, the button 228 may be provided in the form of a substantially rectilinear (or irregular) button body 412 defined by a button first end 414 and a button second end 416 opposing the button first end 414. The button 228 may include a roof 418 extending between the button first end 414 and the button second end 416. When the button 228 is installed on the cap 224 and configured to engage the locking mechanism 226, the roof 418 of the button 228 may be adjacent to or substantially flush with the upper perimeter 394 of the housing 392 (see FIG. 32).

In some instances, the button 228 may include two button sidewalls 420 formed integrally with or coupled to the roof 418 and extending downwardly therefrom. The button sidewalls 420 may be arranged to extend downwardly into the cavity 396 of the cap 224 when the button 228 is installed on the cap 224 (see FIG. 32). For example, a first button sidewall 420a and a second button sidewall 420b may be connected to opposing sides of the roof 418 and extend downwardly therefrom. The first and second button sidewalls 420a, 420b may be substantially similar in shape and structure and may be substantially parallel with respect to one another. Thus, the first and second button sidewalls 420a, 420b may form an enclosure 422 positioned between the first and second button sidewalls 420a, 420b and extending between the button first end 414 and the button second end 416.

In some instances, one or more protrusions 424 may be disposed about an outer edge 426 of the roof 418. For example, the protrusions 424 may be arranged to align with and be received by the indentations 398 disposed about the upper perimeter 394 of the housing 392 of the cap 224 (see FIG. 25). The protrusions 424 may be imparted with any suitable shape, size, or structure, provided that the protrusions 424 are configured be received by or otherwise engage the indentations 398 of the cap 224.

The first button sidewall 420a and the second button sidewall 420b may each include a button pin hole 428 provided in the form of a substantially circular opening extending entirely therethrough. The button 228 may include one or more spring posts 430 arranged to align with the spring platforms 408 positioned inside the cavity 396 of the cap 224 (see FIG. 25). Thus, one or more button springs 432 may be received by the spring posts 430 and extend downwardly therefrom. In some instances, a button spring first end 434 may be received by the spring post 430 and may impact or engage the roof 418, and a button spring second end 436 opposing the button spring first end 434 may impact or be supported by the spring platform 408 within the cavity 396 of the cap 224 (see FIG. 30). In this way, the button springs 432 may apply an upward or a return force to the button 228 (e.g., when the button 228 is depressed to engage the locking mechanism 226).

As best shown in the cross-sectional view of FIG. 27, the button 228 may include an impactor 438 connected to the roof 418 and extending downwardly therefrom. The impactor 438 may be positioned within the enclosure 422 formed by the first and second button sidewalls 420a, 420b. The impactor 438 may be provided in the form of a substantially rectilinear impactor body 440 having an impactor upper end 442 connected to the roof 418 and an impactor lower end 444 extending downwardly into the enclosure 422. In some instances, the impactor 438 may include a curved impact surface 446 at the impactor lower end 444. In other instances, the impactor 438, including the impact surface 446 at the impactor lower end 444, may be imparted with any suitable geometry (e.g., the impact surface 446 may be substantially flat). For example, the button 228 may engage the locking mechanism 226 via the impact surface 446 of the impactor 438, or the impact surface 446 may help to orient the button 228 and one or more components of the locking mechanism 226 with respect to each other.

The button 228 may include a latch 448 connected to the roof 418 and extending downwardly therefrom. For example, a latch upper end 450 may be formed integrally with or coupled to the roof 418 at the button second end 416, and the latch 448 may include a latch hook member 452 at a latch lower end 454 opposing the latch upper end 450. In some instances, the latch hook member 452 may be arranged to engage the ledge 410 of the cap 224 (see FIG. 25) to prevent the button 228 from being unintentionally ejected or separated from the cap 224.

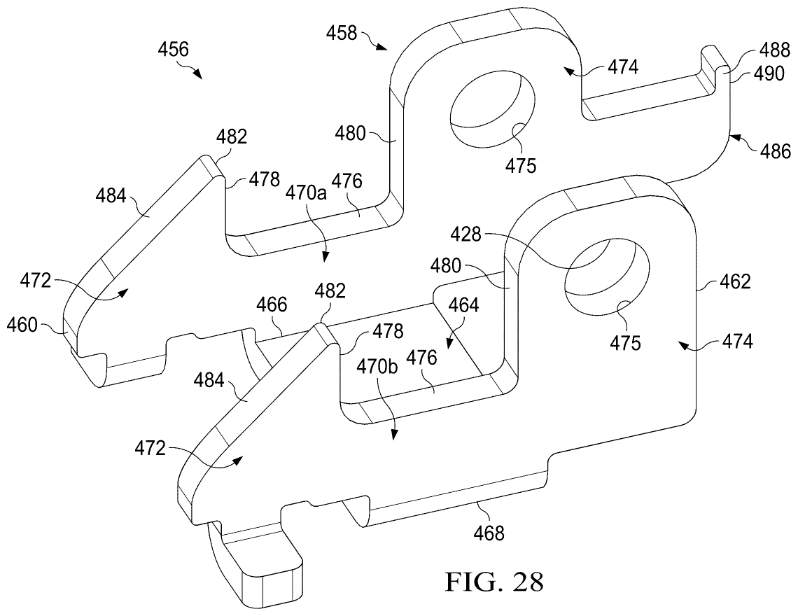

Turning to FIGS. 28-30, an exemplary locking mechanism 226 is depicted. However, it will be understood by those skilled in the art that the locking mechanism 226 may be provided in any suitable form provided that the locking mechanism 226 is designed to prevent or inhibit motion of the slider 230 along the shaft 222 until the locking mechanism 226 is disengaged or released (e.g., by depressing the button 228). Thus, the locking mechanism 226 may be provided in any suitable form known in the art and may include additional and/or alternative parts as compared to the exemplary locking mechanism 226 described herein. In some instances, the locking mechanism 226 may be designed to be operable with one hand.

Referring first to FIG. 28, in some instances, the locking mechanism 226 may include a locking plate 456 provided in the form of a rectilinear locking plate body 458 defined by a locking plate first end 460 and a locking plate second end 462 opposing the locking plate first end 460. The locking plate 456 may include a substantially rectangular base plate 464 defined by a base plate first side 466 and a base plate second side 468 opposing the base plate first side 466. Two vertical panels 470 may be formed integrally with or coupled to the base plate 464 at the base plate first side 466 and the base plate second side 468 and extend upwardly therefrom. For example, a first vertical panel 470a may be connected to the base plate first side 466 and extend upwardly therefrom, and a second vertical panel 470b may be connected to the base plate second side 468 and extend upwardly therefrom. The first and second vertical panels 470a, 470b may each include a pointed barb member 472 proximate to the locking plate first end 460 and a pin tab 474 proximate to the locking plate second end 462.

The pin tabs 474 may each include a locking plate pin hole 475 provided in the form of a substantially circular opening extending entirely therethrough (e.g., the locking plate pin holes 475 may be provided in substantially the same form as the button pin holes 428 shown in FIGS. 26 and 27). The first and second vertical panels 470a, 470b may each include a valley 476 positioned between the barb member 472 and the pin tab 474. The valley 476 may be provided in the form of a substantially flat surface that is sunken or recessed with respect to the barb member 472 and the pin tab 474. For example, the valley 476 may be flanked by a first boundary wall 478 (e.g., a substantially vertical edge of the barb member 472 positioned adjacent to the valley 476) and a second boundary wall 480 (e.g., a substantially vertical edge of the pin tab 474 positioned adjacent to the valley 476). The first and second boundary walls 478, 480 may be substantially perpendicular or oriented at an angle with respect to the valley 476. The barb members 472 may each include a point 482 positioned atop the first boundary wall 478 and an angled surface 484 extending between the point 482 and the locking plate first end 460.

In some instances, one or both of the vertical panels 470 may include a support member 486. For example, in some instances, the first vertical panel 470a may include a support member 486 provided in the form of a substantially rectilinear protrusion connected to the pin tab 474 proximate to the locking plate second end 462 and extending outwardly therefrom. In some instances, the support member 486 may include a lip 488 positioned at a support member distal end 490 and extending upwardly therefrom. In other instances, the support member 486 may be provided in any suitable form or the support member 486 may be omitted.

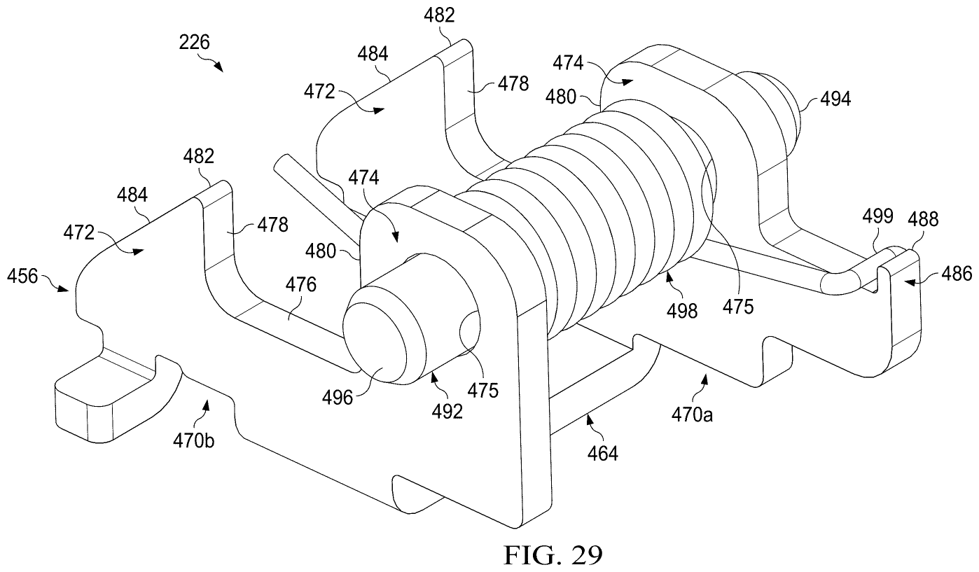

Turning to FIG. 29, the locking mechanism 226 may include a second pin member 492 extending between the pin tabs 474. As shown, a portion of the second pin member 492 may be received by each of the locking plate pin holes 475. In some instances, the second pin member 492 may traverse the entire distance between the pin tabs 474 such that a second pin member first end 494 extends beyond the pin tab 474 of the first vertical panel 470a and a second pin member second end 496 opposing the second pin member first end 494 extends beyond the pin tab 474 of the second vertical panel 470b. In this way, a downward force applied to the second pin member 492 may be transmitted to the locking plate 456 via engagement between the second pin member 492 and the pin tabs 474.

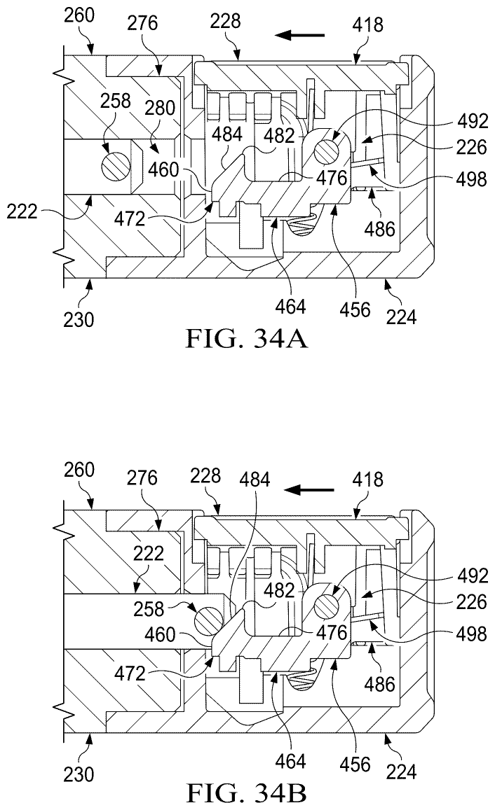

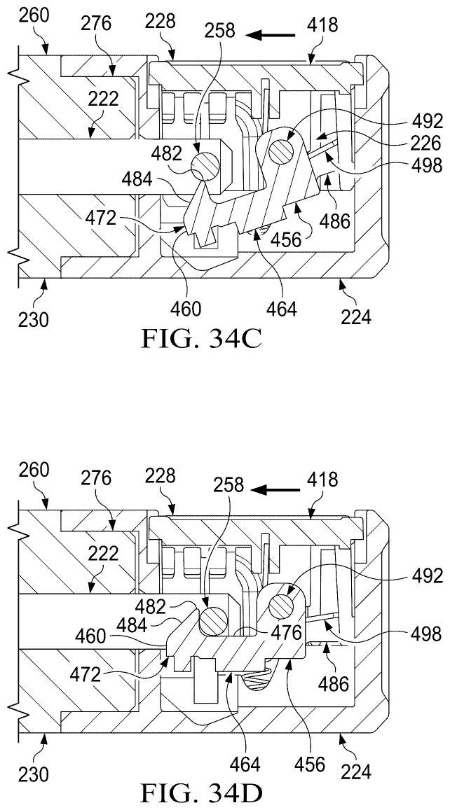

In some instances, the locking mechanism 226 may include a torsion spring 498. For example, the torsion spring 498 may be positioned between the pin tabs 474 (e.g., the torsion spring 498 may surround a portion of the second pin member 492). The torsion spring 498 may include a torsion spring hooked end 499 connected to or positioned to engage the support member 486 of the locking plate 456. In some instances, the torsion spring 498 may facilitate a locking action of the locking mechanism 226, as explained in detail below with reference to FIGS. 34A-34D.

Turning now to FIG. 30, the cap 224 may be coupled to the slider 230 via one or more fasteners 232. For example, fasteners 232 may extend through the one or more cap connection holes 406 positioned on the connection region 390 of the cap 224 configured to align with one or more slider connection holes 278 positioned on the insert 276 of the slider 230 (see FIG. 16). Thus, the cap 224 and the slider 230 may be configured to move in unison. In some instances, the locking mechanism 226 may be positioned within the enclosure 422 of the button 228 and connected to the button 228. For example, the second pin member 492 may extend through the button pin holes 428 such that the button 228 is connected to the locking plate 456, thereby creating a partial assembly. The partial assembly including the locking mechanism 226 and the button 228 may be lowered or inserted into the cavity 396 defined by the housing 392 of the cap 224.

In the view of FIG. 30, the button 228 is removed so that the locking mechanism 226 is shown positioned within the cap 224. The locking mechanism 226 may be arranged within the cavity 396 of the cap 224 such that the locking plate 456 releasably engages the first pin member 258 connected to the shaft 222. For example, the barb members 472 of the locking plate 456 may engage the first pin member 258 when the locking mechanism 226 is engaged, as shown in FIG. 30 (see FIG. 32).

When the outer core 202 of the collapsible core assembly 200 is in the expanded state, a portion of the first pin member 258 may contact or be supported by each of the valleys 476 (see FIG. 29) of the locking plate 456. In some instances, the barb members 472 of the first and second vertical panels 470a, 470b may impact or otherwise engage the first pin member 258 (e.g., via the first boundary walls 478). Engagement between the first pin member 258 and the barb members 472 of the locking plate 456 may prevent the cap 224 and the slider 230 from moving along the shaft 222. The button springs 432 may be positioned on the spring platforms 408 within the cavity 396 of the cap 224 such that the button spring first end 434 of each button spring 432 is available to receive one of the spring posts 430 of the button 228 (see FIG. 26).

Turning to FIGS. 31 and 32, the button 228 may be installed on the cap 224 such that the button 228 facilitates operation of the locking mechanism 226 (e.g., the button 228 may be operable to release the locking mechanism 226). As best shown in FIG. 31, the roof 418 of the button 228 may be configured to fit within or be received by the upper perimeter 394 of the cap 224. For example, the protrusions 424 of the button 228 (see FIG. 26) may align with and be received by the indentations 398 of the cap 224 (see FIG. 25).

As shown in the cross-sectional view of FIG. 32, the first and second button sidewalls 420a, 420b may extend downwardly into the cavity 396 defined by the housing 392 of the cap 224. The first and second vertical panels 470a, 470b of the locking plate 456 may be positioned within the enclosure 422 (see FIG. 26) defined by the first and second button sidewalls 420a, 420b. In some instances, the first and second vertical panels 470a, 470b may abut or be positioned adjacent to the first and second button sidewalls 420a, 420b, respectively. The locking plate pin holes 475 (see FIG. 28) may align with the button pin holes 428 (see FIGS. 26 and 27) when the locking mechanism 226 and button 228 are installed or positioned within the cap 224.

Thus, the second pin member first end 494 may extend through the locking plate pin hole 475 of the first vertical panel 470a and the adjacent button pin hole 428. Likewise, the second pin member second end 496 may extend through the locking plate pin hole 475 of the second vertical panel 470b (see FIG. 29) and the adjacent button pin hole 428. In this way, the second pin member 492 may facilitate a connection or coupling between the button 228 and the locking plate 456 of the locking mechanism 226. For example, a downward force applied to the button 228 (e.g., when a user presses down on the roof 418) may be transmitted to the locking plate 456 via the second pin member 492. In some instances, the second pin member 492 may define an axis of rotation of the locking plate 456 or the locking plate 456 may be configured for rotation about the second pin member 492 when the locking mechanism 226 is operated.

The button springs 432 extending between the spring platforms 408 of the cap 224 (see FIG. 25) and the spring posts 430 of the button 228 may bias the button 228 toward a default position (shown in FIG. 32). In the default position, upward pressure applied by the button springs 432 may cause the roof 418 of the button 228 to be positioned adjacent to or substantially flush with the upper perimeter 394 of the housing 392 of the cap 224. The latch hook member 452 of the latch 448 at the button second end 416 (see FIG. 27) may engage the ledge 410 within the cavity 396 of the cap 224 (see FIG. 25), thereby limiting the extent to which the button springs 432 can elevate the button 228 with respect to the cap 224. In some instances, the latch 448 of the button 228 and the ledge 410 of the cap 224 may be designed to prevent the button springs 432 from pushing the roof 418 of the button 228 above the upper perimeter 394 of the cap 224. In some instances, the latch 448 of the button 228 and the ledge 410 of the cap 224 may be designed to ensure that the roof 418 of the button 228 is substantially flush with the cap 224.

Turning to FIGS. 33A-33C, in some instances, an unlocking action of the locking mechanism 226 may include one or more unlocking orientations or positions. For example, at a first unlocking orientation shown in FIG. 33A, the locking mechanism 226 may be in a default or locked position. When the locking mechanism 226 is in the default or locked position, the locking plate 456 of the locking mechanism 226 engages the first pin member 258 and the roof 418 of the button 228 is substantially in alignment with the upper perimeter 394 of the cap 224 (see FIG. 25). For example, a portion of the first pin member 258 may be positioned within the valley 476 of the first vertical panel 470a (e.g., engaging the first boundary wall 478 of the first vertical panel 470a) and a portion of the first pin member 258 may be positioned within the valley 476 of the second vertical panel 470b (e.g., engaging the first boundary wall 478 of the second vertical panel 470b).

At a second unlocking orientation shown in FIG. 33B, the locking mechanism 226 may be moved to a disengaged position by a user depressing the button 228 in order to disengage the locking mechanism 226. For example, a user may apply a downward force to the roof 418 of the button 228, and the downward force may be transmitted to the locking plate 456 via engagement of the second pin member 492 with the button 228 and the locking plate 456. Thus, the downward force applied to the button 228 may cause the locking plate 456 to move downward (e.g., further into the cavity 396) such that the first pin member 258 clears the points 482 of the barb members 472 and no longer engages the locking plate 456. The locking mechanism 226 may be disengaged when the points 482 of the barb members 472 clear the first pin member 258, and the cap 224 and the slider 230 may become movable with respect to the shaft 222.

At a third unlocking orientation shown in FIG. 33C, the locking mechanism 226 may be in a slidable or movable position. When the locking mechanism 226 is in the slidable or movable position, a user may grip and pull the cap 224 away from the shaft 222 in order to move the slider 230 along the shaft 222 after depressing the button 228 to disengage the locking mechanism 226. In some instances, with reference to FIG. 12, the pressure generated by the compressed spring 298 contacting the distal ends 270 of the upper and lower arms 262, 264 of the slider 230 may aid in generating motion of the slider 230 away from the shaft first end 242 once no longer opposed by the engagement between the first pin member 258 and the locking plate 456. For example, the force contributed by the spring 298 may reduce the amount of force required from a user to pull the cap 224 and move the slider 230 along the shaft 222. The roof 418 of the button 228 may return to being in substantial alignment with the upper perimeter 394 of the cap 224 during the third unlocking orientation. For example, the user may release the button 228 (e.g., allowing the button springs 432 to elevate the button 228 with respect to the cap 224) once the cap 224 has been retracted such that the locking plate first end 460 moves away from the first pin member 258.

Turning to FIGS. 34A-34D, a locking action of the locking mechanism 226 may include one or more locking orientations or positions. In some instances, at the beginning of a first locking orientation, the locking mechanism 226 may be in the slidable or movable position such that the cap 224, locking mechanism 226, and button 228 may be in substantially the same configuration as in the third unlocking orientation discussed above with respect to FIG. 33C. At the first locking orientation shown in FIG. 34A, a user may grip the cap 224 and push the cap 224 toward the shaft 222 until the locking mechanism 226 reengages or contacts the first pin member 258.

At a second locking orientation shown in FIG. 34B, the locking mechanism 226 may be in a first reengagement position. In the first reengagement position, the locking plate 456 may contact the first pin member 258. For example, the angled surfaces 484 of the barb members 472 on the first vertical panel 470a and the second vertical panel 470b (see FIG. 28) may contact the first pin member 258 as the cap 224 moves in the direction of the shaft 222. The user may continue to move the cap 224 in the direction of the shaft 222 such that the locking plate 456 rotates about the second pin member 492. For example, engagement between the first pin member 258 and the angled surfaces 484 of the barb members 472 may impart a downward force to the locking plate 456 at the locking plate first end 460.

At a third locking orientation shown in FIG. 34C, the locking mechanism 226 may be in a second reengagement position. In the second reengagement position, the downward force applied to the angled surfaces 484 of the barb members 472 by the first pin member 258 may cause the locking plate first end 460 to rotate downwardly with respect to the first pin member 258. For example, the locking plate 456 may rotate about the second pin member 492 until the points 482 of the barb members 472 move under the first pin member 258.

At a fourth locking orientation shown in FIG. 34D, the locking mechanism 226 may return to the default or locked position (see also FIG. 33A). To return the locking mechanism 226 to the default or locked position, a user may continue to move the cap 224 in the direction of the shaft 222 until the locking mechanism 226 is reengaged. For example, the user may continue moving the cap 224 until the first pin member 258 no longer contacts or engages the angled surfaces 484 or the points 482 of the barb members 472. The torsion spring 498 may be configured to apply a return force to the locking plate 456 such that the locking plate 456 returns to the position depicted in the first unlocking orientation shown in FIG. 33A. For example, the torsion spring 498 may bias the locking plate 456 toward an orientation where the base plate 464 of the locking plate 456 is substantially parallel with the shaft 222. Thus, the return force applied by the torsion spring 498 may cause the locking plate 456 to rotate back into engagement with the first pin member 258 (e.g., such that the first pin member 258 contacts or engages the valleys 476 and/or the barb members 472 of the locking plate 456). When the locking action is complete, the locking mechanism 226 may inhibit movement of the slider 230 along the shaft 222 until the unlocking action is performed and the locking plate 456 is again disengaged from the first pin member 258.

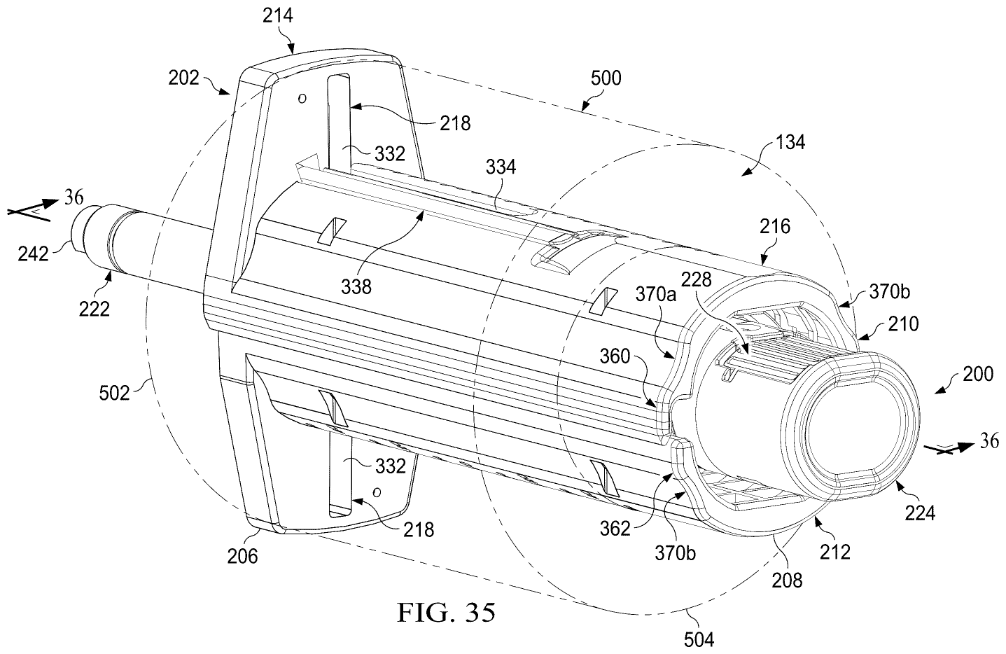

Turning to FIGS. 35-38, the wipers 220 may be configured to partially remove a spool 500 of used ribbon material 134 from the collapsible core assembly 200. Referring first to FIG. 35, the outer core 202 may be in the expanded state during operation of a printing device (e.g., the printer 100). Used ribbon material 134 may accumulate on the spindle arm 216 of the outer core 202 while the printing device operates (e.g., as ribbon material 134 is unwound from the ribbon supply spindle 130 and guided to the collapsible core assembly 200 along the desired ribbon path as shown in FIG. 3). In this way, used ribbon material 134 may produce the spool 500 of wound used ribbon material 134 having a spool first end 502 adjacent to the end wall 214 and a spool second end 504 opposing the spool first end 502 (e.g., proximate to the outer core second end 208).

As best shown in FIG. 36, the outer core 202 may be maintained in the expanded state via engagement between the first ramp surfaces 234 and the second ramp surfaces 235 of the slider 230 and the first ramp members 236 and the second ramp members 237 of the outer core 202. In some instances, the spool 500 may apply a tension or an inward pressure to the outer core 202 as the used ribbon material 134 is wound about the spindle arm 216. However, the tension or pressure applied by the spool 500 may be opposed by engagement between the first ramp surfaces 234 and the first ramp members 236 and/or the second ramp surfaces 235 and the second ramp members 237.

The slider 230 may occupy a first position when the outer core 202 is in the expanded state. In the first position, the slider 230 may be disposed between the upper portion 210 and lower portion 212 of the outer core 202 (e.g., held in place by the locking mechanism 226) such that the first and second ramp surfaces 234, 235 align with and engage the first and second ramp members 236, 237. For example, the first ramp surface 234 of the upper arm 262 may align with and engage the first ramp member 236 of the upper portion 210, the second ramp surfaces 235 of the upper arm 262 may align with and engage the second ramp members 237 of the upper portion 210, the first ramp surface 234 of the lower arm 264 may align with and engage the first ramp member 236 of the lower portion 212, and the second ramp surfaces 235 of the lower arm 264 may align with and engage the second ramp members 237 of the lower portion 212. In some instances, the first ramp members 236 may contact or engage the first ramp surface summit 275 of the associated first ramp surface 234, and the second ramp members 237 may contact or engage the second ramp surface summit 273 of the associated second ramp surface 235 (see, e.g., FIG. 9).

In the first position, the insert 276 of the slider 230 may be positioned within the outer core 202 adjacent to the outer core second end 208, and the distal ends 270 of the upper arm 262 and lower arm 264 may be positioned within the outer core 202 proximate to the end wall 214. The first and second wipers 220a, 220b may be coupled to the upper and lower arms 262, 264 of the slider 230, and the wiping members 288 of the first and second wipers 220a, 220b may be oriented at an angle or may be substantially perpendicular with respect to the shaft 222. In some instances, the wiping members 288 may be positioned within the end wall 214 (e.g., housed within the upright portions 332 of the outer core channels 218) when the slider 230 is in the first position (see FIG. 22).

Thus, the spindle arm 216 may be defined by a first diameter D₁ when the slider 230 is in the first position and the outer core 202 is in the expanded state. In some instances, the first diameter D₁ may be imparted with a value of about 45 millimeters (mm) to about 55 mm (or 45 mm to 55 mm). For example, the first diameter D₁ may be imparted with a value of at least about 45 mm (or at least 45 mm), or at least about 46 mm (or at least 46 mm), or at least about 47 mm (or at least 47 mm), or at least about 48 mm (or at least 48 mm), or at least about 49 mm (or at least 49 mm), or at least about 50 mm (or at least 50 mm), or at least about 51 mm (or at least 51 mm), or at least about 52 mm (or at least 52 mm), or at least about 53 mm (or at least 53 mm), or at least about 54 mm (or at least 54 mm), or at least about 55 mm (or at least 55 mm). In some instances, the first diameter D₁ may be imparted with a value of about 50 mm (or 50 mm).

The spring 298 surrounding the shaft 222 may store potential energy (e.g., elastic potential energy) when the slider 230 is in the first position and the outer core 202 is in the expanded state. For example, the spring 298 may be compressed between the backplate 314 of the inner core 238 and the distal ends 270 of the upper arm 262 and lower arm 264. In other instances, the spring 298 may be compressed between the distal ends 270 of the upper arm 262 and lower arm 264 and another component of the collapsible core assembly 200 positioned proximate or adjacent to the backplate 314. As can be seen in FIG. 36, engagement between the first pin member 258 connected to the shaft 222 and the barb members 472 of the locking plate 456 (see also FIG. 30) may prevent the potential energy of the spring 298 from being released, for example, by the distal ends 270 of the upper arm 262 and lower arm 264 moving in the direction of the outer core second end 208.

Turning to FIGS. 37 and 38, the collapsible core assembly 200 may perform a wiping action that at least partially removes the spool 500 of used ribbon material 134 from the spindle arm 216. The wiping action may involve (i) performing the unlocking action of the locking mechanism 226 described above with reference to FIGS. 33A-33C, (ii) moving the slider 230 from the first position to a second position, and (iii) transitioning the outer core 202 from the expanded state to the collapsed state.

For example, a user may initiate the wiping action by engaging (e.g., depressing) the button 228 in order to release the locking mechanism 226 as explained in detail above with reference to FIGS. 33A-33C. The user may terminate the engagement between the first pin member 258 of the shaft 222 and the barb members 472 of the locking plate 456 by depressing or otherwise engaging the roof 418 of the button 228. When the first pin member 258 clears the points 482 of the barb members 472, the slider 230 may become movable along the shaft 222 in the direction of the outer core second end 208 (see FIGS. 33A-33C).

Upon the release of the locking mechanism 226, a user may grip and pull the cap 224 in the direction of a first arrow 506. Additionally, at least a portion of the potential energy stored in the spring 298 may be converted to kinetic energy and transmitted to the slider 230 via the distal ends 270 of the upper and lower arms 262, 264. Thus, in some instances, the spring 298 may cause the slider 230 to move in the direction of the first arrow 506. Therefore, the force applied by the spring, the force applied by the user, or a combination thereof may cause the slider 230 to move from the first position (see FIG. 36) to the second position, as depicted in FIG. 37. In some instances, a user may disengage the locking mechanism 226 and move the slider 230 between the first position and the second position using only one hand.

With the slider 230 in the second position, the insert 276 and at least a portion of the hub region 260 may extend beyond the outer core second end 208. The wipers 220 may be configured to move in the direction of second arrows 508 via the inner core channels 312 (see FIG. 13) and the wiper paths 334 of the outer core channels 218 (see FIG. 17) as the slider 230 moves from the first position to the second position. In some instances, the wipers 220 may move away from the end wall 214 along the spindle arm 216 until the wiping members 288 reach the terminal end 336 of the wiper path 334 (see FIG. 22). In this way, the wipers 220 may engage the spool first end 502 and at least partially eject or remove the used ribbon material 134 from the spindle arm 216. For example, as shown, the spool second end 504 may extend beyond the outer core second end 208 when the wiping members 288 reach the terminal end 336.

Movement of the slider 230 from the first position to the second position may cause the outer core 202 to transition from the expanded state to the collapsed state. For example, movement of the slider 230 in the direction of the first arrow 506 may cause the first and second ramp surfaces 234, 235 of the slider 230 to move out of alignment with the first and second ramp members 236, 237 of the outer core 202, respectively. In turn, the upper portion 210 and lower portion 212 of the outer core 202 may transition into the collapsed state. For example, the upper and lower portions 210, 212 may move closer to one another in response to a tension in the spool 500 applying an inward force to the outer core 202, an inward pressure applied by another component of the collapsible core assembly 200, gravity, other inward pressures or forces, or a combination thereof. In some instances, the seat members 360 may receive or contact the peg members 362 (see FIG. 21) when the outer core 202 is in the collapsed state.

The spindle arm 216 may be defined by a second diameter D₂ when the slider 230 is in the second position and the outer core 202 is in the collapsed state. The second diameter D₂ may be less than the first diameter D₁. In some instances, the second diameter D₂ may be imparted with a value of about 47 mm to about 57 mm (or 47 mm to 57 mm). For example, the second diameter D₂ may be imparted with a value of at least about 47 mm (or at least 47 mm), or at least about 48 mm (or at least 48 mm), or at least about 49 mm (or at least 49 mm), or at least about 50 mm (or at least 50 mm), or at least about 51 mm (or at least 51 mm), or at least about 52 mm (or at least 52 mm), or at least about 53 mm (or at least 53 mm), or at least about 54 mm (or at least 54 mm), or at least about 55 mm (or at least 55 mm), or at least about 56 mm (or at least 56 mm), or at least about 57 mm (or at least 57 mm). In some instances, the second diameter D₂ may be imparted with a value of about 42.5 mm (or 42.5 mm).

In some instances, a reduction of the diameter of the spindle arm 216 from the first diameter D₁ to the second diameter D₂ may release or reduce a tension in the spool 500 such that the used ribbon material 134 may be more easily removed from the spindle arm 216.

Turning to FIG. 38, a user may complete removal of the spool 500 from the spindle arm 216 by pushing or pulling the spool first end 502 in the direction of a third arrow 510 until the spool first end 502 clears the outer core second end 208. In some instances, the removal grooves 370 may aid a user in completing the removal of the spool 500. For example, the user may position one or more fingers and/or thumbs in one or more of the removal grooves 370 and push or pull along the removal grooves 370 until the spool 500 is removed from the spindle arm 216. The removal grooves 370 may help ensure that the innermost layers of used ribbon material 134 are removed with the rest of the spool 500 (e.g., by allowing a user to better position their fingers and/or thumbs beneath the innermost layers of ribbon material 134).

When the spool 500 of used ribbon material 134 has been removed from the spindle arm, the collapsible core assembly 200 may revert to its initial configuration (e.g., for use with a newly installed ribbon roll 136). For example, a user may grip the cap 224 and push or move the slider 230 toward the end wall 214 to return the slider 230 to the first position and perform the locking action of the locking mechanism 226 described above with reference to FIGS. 34A-34D. The spring 298 may be compressed as the distal ends 270 of the upper and lower arms 262, 264 of the slider 230 move closer to the end wall 214 (see FIG. 36). The first and second ramp surfaces 234, 235 of the slider 230 may move back into alignment with the first and second ramp members 236, 237 of the outer core 202, respectively, when the slider 230 returns to the first position (see FIG. 36).

Thus, movement of the slider 230 from the second position to the first position may cause the outer core 202 to transition from the collapsed state to the expanded state (e.g., due to engagement between the first and second ramp surfaces 234, 235 and the first and second ramp members 236, 237, respectively). When the slider 230 returns to the first position, the wiping members 288 of the wipers 220 may once again be positioned within the upright portions 332 of the outer core channels 218 (see FIG. 22). For example, the return of the slider 230 to the first position may cause the wiping members 288 to travel from the terminal end 336 of the wiper path 334 to a position within the end wall 214. As the slider 230 approaches the first position, the locking action of the locking mechanism described above with reference to FIGS. 34A-34D may be performed such that the slider 230 is maintained in the first position and the outer core 202 is maintained in the expanded state (e.g., while another spool 500 of used ribbon material 134 accumulates on the spindle arm 216).

In some instances, the spool 500 may be completely removed from the spindle arm 216 before the slider 230 is returned to the first position. In other instances, the slider 230 may be returned to the first position before the spool 500 is completely removed from the spindle arm 216.

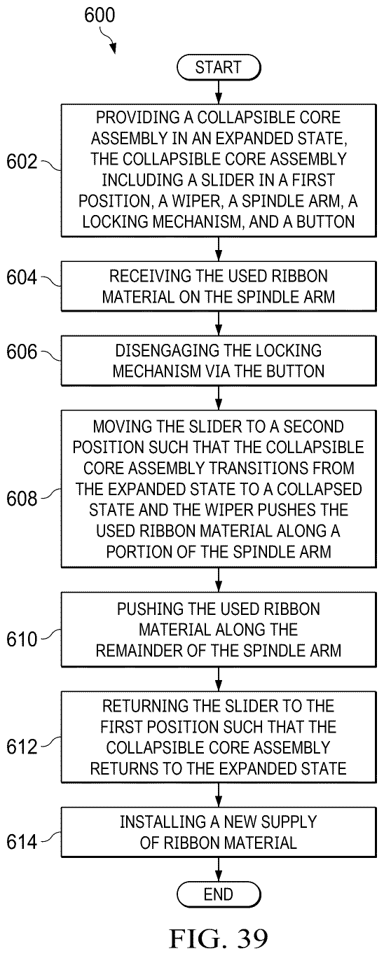

FIG. 39 illustrates a method 600 of removing or ejecting used ribbon material (e.g., 134) from a spindle (e.g., waste ribbon spindle 132) in a printer (e.g., printer 100) according to the principles of the present disclosure.

At a step 602, a collapsible core assembly (e.g., the collapsible core assembly 200) is provided in an expanded state (see, e.g., FIGS. 4 and 5). The collapsible core assembly includes a slider (e.g., slider 230) disposed on a shaft (e.g., central shaft 222) movably connected to the printer. The slider is disposed in a first position (see, e.g., FIG. 36) along the shaft. The collapsible core assembly may also include a wiper (e.g., first or second wiper 220a, 220b) connected to the slider, a spindle arm (e.g., spindle arm 216) partially surrounding the slider for collecting the used ribbon material. The spindle arm may have a first end (e.g., outer core first end 206) and a second end (e.g., outer core second end 208), and the wiper may be disposed proximate the first end of the spindle arm. The collapsible core assembly may further include a locking mechanism (e.g., locking mechanism 226) operably engaging the slider and a button (e.g., button 228) operably connected to the locking mechanism. In some instances, collapsible core assembly may also include an outer core (e.g., outer core 202) that includes ramp members (e.g., first ramp members 236 and/or second ramp members 237) and the slider may include ramp surfaces (e.g., first ramp surfaces 234 and/or second ramp surfaces 235) and engagement between the ramp surfaces and the ramp members may maintain the collapsible core assembly in the expanded state.

At a step 604, ribbon material (e.g., ribbon material 134) is used during operation of a printing device (e.g., the printer 100) and the used ribbon material (e.g., used ribbon material 134) is received by the spindle arm. The used ribbon material may form a spool (e.g., spool 500) of used ribbon material positioned between the first end and the second end of the spindle arm.

At a step 606, the locking mechanism is disengaged by depressing the button. Depressing the button, releases the slider from the first position such that the slider becomes movable along the shaft toward the second end of the spindle arm. The central shaft may be configured to remain stationary during movement of the slider.

At a step 608, the slider moves from the first position to a second position (see, e.g., FIG. 37). The movement of the slider from the first position to the second position causes the collapsible core assembly to transition to a collapsed state (see, e.g., FIGS. 37 and 38) and causes the wiper to push the used ribbon material along a portion of the spindle arm, thereby partially removing the used ribbon material from the spindle arm. More specifically, in some instances, the wiper attached to the slider may travel from the first end of the spindle arm toward the second end of the spindle arm, thereby pushing the used ribbon material away from the first end of the spindle arm and toward the second end. The ramp surfaces may disengage the ramp members such that the outer core transitions from the expanded state to a collapsed state.

At a step 610, the used ribbon material is pushed along the remainder of the spindle arm until the used ribbon material is removed from the collapsible core assembly.

At a step 612, the slider is returned to the first position and the collapsible core assembly returns to the expanded state. In some instances, the ramp surfaces of the slider may reengage the ramp members of the outer core, and the outer core may be returned to the expanded state. The locking mechanism may become reengaged when the slider returns to the first position.

At a step 614, a new supply of ribbon material is installed in the printing device. The printing device may then perform further operations and a new spool of used ribbon material may accumulate on the spindle arm.

It will be appreciated by those skilled in the art that while the above disclosure has been described above in connection with particular embodiments and examples, the above disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference as if each such patent or publication were individually incorporated by reference herein. Various features and advantages of the above disclosure are set forth in the following claims.

1. A spindle for facilitating removal of used ribbon material in a printer, comprising:
a shaft movably attached to the printer;
a spindle arm positioned on the shaft for collecting the used ribbon material, the spindle arm having a first side and a second side opposite the first side;
a slider disposed between the shaft and the spindle arm and configured for bidirectional movement along the shaft between a first position and a second position;
a first wiper connected to the slider; and
a button connected to the slider and operably engaging the shaft,
wherein engaging the button permits movement of the slider along the shaft from the first position to the second position thereby causing the first wiper to move the used ribbon material toward an end of the spindle arm.

2. The spindle of claim 1, further comprising:
a locking mechanism operably connected to the button and capable of being in an engaged state or a disengaged state,
wherein the locking mechanism maintains the slider in the first position while the locking mechanism is in the engaged state, and
wherein depressing the button causes the locking mechanism to transition from the engaged state to the disengaged state thereby releasing the slider from the first position.

3. The spindle of claim 2, wherein the locking mechanism engages a pin member connected to the shaft when the locking mechanism is in the engaged state.

4. The spindle of claim 1, further comprising a spring disposed along the shaft and in contact with the slider, the spring biasing the slider toward the second position.

5. The spindle of claim 1, further comprising:
a first groove disposed on the first side of the spindle arm; and
a second groove disposed on the second side of the spindle arm,
wherein one or more of the first groove or the second groove enable a user's finger to contact an underside of the used ribbon material collected on the spindle arm to aid in removal of the used ribbon material from the spindle arm when the slider is in the second position.

6. The spindle of claim 1, wherein a user can engage the button and generate movement of the slider between the first position and the second position using one hand.

7. The spindle of claim 1, further comprising an outer core surrounding at least a portion of the shaft and the slider, the outer core including a first channel oriented along a portion of the spindle arm;
an inner core positioned between the slider and the outer core, the inner core including a second channel configured to align with the first channel,
wherein the first channel and the second channel permit the first wiper to travel along a portion of the spindle arm toward the end of the spindle arm.

8. The spindle of claim 7, wherein the inner core includes a guide member configured to engage with a guide wall of the outer core and inhibit movement of the outer core with respect to the inner core.

9. The spindle of claim 1, wherein the slider includes a first arm and a second arm that is substantially parallel to the first arm, wherein the first wiper is connected to the first arm and a second wiper is attached to the second arm.

10. A collapsible core assembly for collecting used ribbon material in a printer, comprising:
a shaft;
a slider at least partially surrounding the shaft and configured to move therealong;
a wiper connected to the slider; and
an outer core at least partially surrounding the slider, the outer core forming a spindle arm configured to collect the used ribbon material,
wherein the outer core is in an expanded state during operation of the printer, and
wherein the outer core is in a collapsed state during removal of the used ribbon material from the spindle arm.

11. The spindle of claim 10, wherein the slider includes a first ramp surface and a second ramp surface,
wherein the outer core includes a first ramp member and a second ramp member that are positioned to align with the first ramp surface and the second ramp surface of the slider, respectively, and
wherein engagement between the first and second ramp surfaces and the first and second ramp members, respectively, maintains the outer core in the expanded state.

12. The spindle of claim 11, wherein the slider is movable between a first position and a second position, and
wherein the outer core transitions from the expanded state to the collapsed state when the slider moves from the first position to the second position.

13. The spindle of claim 12, wherein the first and second ramp surfaces of the slider engage the first and second ramp members of the outer core, respectively, when the outer core is in the expanded state; and
wherein the first and second ramp surfaces of the slider do not engage the first and second ramp members of the outer core, respectively, when the outer core is in the collapsed state.

14. The spindle of claim 10, wherein the outer core includes an upper portion and a lower portion, and wherein the upper portion and the lower portion are retained at a distance from one another when the outer core is in the expanded state.

15. The spindle of claim 14, wherein the upper portion contacts the lower portion when the outer core is in the collapsed state.

16. The spindle of claim 10, wherein a transition of the outer core from the expanded state to the collapsed position reduces a tension on the used ribbon material collected on the spindle arm.

17. The spindle of claim 10, further including:
a cap coupled to the slider; and
a locking mechanism retained within the cap, the locking mechanism inhibiting motion of the slider with respect to the outer core.

18. The spindle of claim 17, wherein the locking mechanism holds the slider in a first position, and wherein the slider is movable from the first position to a second position when the locking mechanism is disengaged.

19. The spindle of claim 17, further comprising:
a button disposed within the cap and operably engaging the locking mechanism,
wherein pressing the button disengages the locking mechanism and permits the slider to perform a wiping action wherein the wiper partially removes the used ribbon material from the spindle arm.

20. A method of removing used ribbon material from a printer, comprising:
providing a collapsible core assembly in an expanded state, including:
a slider disposed on a shaft movably connected to the printer, the slider disposed in a first position along the shaft;
a wiper connected to the slider;
a spindle arm partially surrounding the slider for collecting the used ribbon material;
a locking mechanism operably engaging the slider; and
a button operably connected to the locking mechanism;
receiving the used ribbon material on the spindle arm;
disengaging the locking mechanism by depressing the button to release the slider from the first position;
moving the slider along the shaft to a second position, wherein movement of the slider from the first position to the second position causes the collapsible core assembly to transition to a collapsed state and causes the wiper to push the used ribbon material along a portion of the spindle arm, thereby partially removing the used ribbon material from the spindle arm;
pushing the used ribbon material along the remainder of the spindle arm until the used ribbon material is removed from the collapsible core assembly; and
returning the slider to the first position such that the collapsible core assembly returns to the expanded state.
